(19) United States
(12) Patent Application Publication
(10) Pub. No.: US 2006/0014013 A1
(43) Pub. Date: Jan. 19, 2006

(54) Stabilized biocompatible supported lipid membrane

(76) Inventors: Steven Scott Saavedra, Tucson, AZ (US); David F Obrien, Tucson, AZ (US); Eric E Ross, Philadelphia, PA (US); Bruce Bondurant, Tucson, AZ (US); John C Conboy, Salt Lake City, UT (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/469,539

(22) PCT Filed: Mar. 11, 2002
(86) PCT No.: PCT/US02/07369

§ 371 Date: Dec. 23, 2004

Related U.S. Application Data
(60) Provisional application No. 60/274,597, filed on Mar. 10, 2001.
(60) Provisional application No. 60/362,540, filed on Mar. 8, 2002.

(51) Int. Cl. B05D 3/02; B32B 9/04; B32B 27/00

(52) U.S. Cl. 428/338; 427/487; 427/372.2; 428/411.1; 428/500

(57) ABSTRACT

A lipid membrane is self-assembled and stabilized at a solid surface by depositing a lipid monolayer or a lipid multilayer on a substrate, otaining a supported lipid monolayer or a supported lipid multilayer; and in situ polymerizing the supported lipid monolayer or the supported lipid multilayer, thereby obtaining a polymerized membrane.

### RELATED APPLICATIONS

This application claims priority to provisional U.S. patent application 60/274,591, filed Mar. 9, 2001, and provisional U.S. patent application entitled “Stabilized, Biocompatible Supported Lipid Membrane,” filed Mar. 8, 2002, both of which, and all references and patent applications cited therein are incorporated herein by reference.

### BACKGROUND OF THE INVENTION

1. Field of the Invention

The present invention relates to a self-assembled lipid membrane, in the form of a monolayer, bilayer, or multilayer, that is stabilized on a solid support.

2. Discussion of the Background

The development of durable, biomembrane-mimetic coatings for inorganic and polymeric surfaces that are resistant to nonspecific protein adsorption (protein resistant) is impacting numerous fields (Sackman, E., Science, 1996, 271, 43; Plant, A. L., Langmuir, 1999, 15, 5128; Marra, K. G.; Winger, T. M.; Hanson, S. R.; Chaikof, E. L., Macromolecules, 1997; 30, 6483; Wisniewski, N.; Reichert, M., Coll. Surf. B: Biointerfaces, 2000, 18, 197-219).

One example is the design of a biosensor surface at which a ligand binding event must be detected in the presence of numerous other non-target proteins (Wisniewski, N.; Reichert, M., Coll. Surf. B: Biointerfaces 2000, 18, 197-219; Stelzle, M.; Weissmuller, G.; Sackman, E., J. Phys. Chem., 1993, 97, 2974; Duschl, C.; Liley, M.; Corradin, G.; Vogel, H., Biophys. J., 1994, 67, 1229; Song, X. D.; Swanson, B. I., Anal. Chem., 1999, 71, 2097; Parikh, A. N.; Beers, J. D.; Shreve, A. P.; Swanson, B. I., Langmuir, 1999, 15, 5369; Fischer, B.; Heyn, S. P.; Egger, M.; Gaub, H. E., Langmuir, 1993, 9, 136).

In most optical and electrochemical sensors, the transducer is an oxide or noble metal surface to which dissolved proteins can irreversibly adsorb, “fouling” the sample/transducer interface. Planar lipid monolayer, bilayer, and multilayer structures have been used to coat such surfaces (Sackman, E., Science, 1996, 271, 43; Plant, A. L., Langmuir, 1999, 15, 5128; Song, X. D.; Swanson, B. I., Anal. Chem., 1999, 71, 2097; Parikh, A. N.; Beers, J. D.; Shreve, A. P.; Swanson, B. I., Langmuir, 1999, 15, 5369; Fischer, B.; Heyn, S. P.; Egger, M.; Gaub, H. E., Langmuir, 1993, 9, 136; Thompson, N. L.; Palmer, A. G., Comments Mol. Cell. Biophys., 1988, 5, 39; Watts, T. H.; Gaub, H. E.; McConnell, H. M., Nature, 1986, 320, 179; McConnell, H. M.; Watts, T. H.; Weis, R. M.; Brian, A. A., Biochim. Biophys. Acta., 1986, 864, 95; Meuse, C. W.; Krueger, S.; Majkrzak, C. F.; Dura, J. A.; Fu, J.; Connor, J. T.; Plant, A. L., Biophys. J., 1998, 74, 1388; Kalb, E.; Frey, S.; Tanun, L. K., Biochim. Biophys. Acta., 1992, 1103, 307; Edmiston, P. L.; Saavedra, S. S., Biophys. J., 1998, 74, 999; Majewski, J.; Wong, J. Y.; Park, C. K.; Seitz, M.; Israelachvili, J. N.; Smith, G. S., Biophys. J., 1998, 75, 2363; Hillebrandt, H.; Wiegrand, G.; Tanaka, M.; Sackmann, E., Langmuir, 1999, 15, 8451).

Such lipid monolayers, bilayers, or multilayers offer the ability to minimize sensor “fouling”, i.e., the undesirable adsorption of non-target proteins and biomolecules invariably present in complex biological matrices, by exploiting the characteristic protein adsorption resistance associated with the phosphorylcholine (PC) lipid headgroup (Hayward, J.; Chapman, D., Biomaterials, 1984, 5, 135; Chapman, D., Langmuir, 1993, 9, 39; Malmsten, M. J., Colloid Interface Sci., 1995, 171, 106; Murphy, I. F.; Lu, J. R.; Lewis, L. L.; Brewer, J.; Russell, J.; Stratford, P., Macromolecules, 2000, 33, 4545). Additionally, their well-defined and controllable architecture may allow for favorable orientation and minimal denaturation of immobilized antigens or biomolecules such as fab antibody fragments, to maximize sensitivity of the device (Song, X. D.; Swanson, B. I., Anal. Chem., 1999, 71, 2097; Parikh, A. N.; Beers, J. D.; Shreve, A. P.; Swanson, B. I., Langmuir, 1999, 15, 5369; Fischer, B.; Heyn, S. P.; Egger, M.; Gaub, H. E., Langmuir, 1993, 9, 136; Viitala, T.; Vikholm, I.; Peltonen, J., Langmuir, 2000, 16, 4953-4961; Duschle, C.; Se(slash)vin-Landais, A. F.; Vogel, H., Biophys., 1996, 70, 1985-1995).

Supported lipid membrane structures also provide the necessary environment for transmembrane receptor incorporation, which has been demonstrated by several authors through the fabrication of proteo-lipid structures with retained protein activity (Salafsky, J.; Groves, J. T.; Boxer, S. G., Biochem., 1996, 35, 14773-14781; Schmidt, E. X.; Liebermann, T.; Kreiter, M.; Jonczyk, A.; Naumann, R.; Offenhäusser, A.; Neumann, E.; Kukol, A.; Maelicke, A.; Knoll, W., Biosensors Bioelectronics, 1998, 13, 585-591; Naumann, R; Jonczyk, A.; Hampel, C.; Ringsdorf, H.; Knoll, W.; Bunjes, N., Gräber, P. Bioelectrochemistry and Bioenergetics, 1997, 42, 241-247; Fisher, M. L; Tjärnhage, T., Biosensors and Bioelectronics, 2000, 15, 463-471; Pun, G.; Gustafson, L; Artursson, E.; Ohlsson, P. A., Biosensors and Bioelectronics 1995, 10, 463-476; Puu, G.; Aartursson, E.; Gustafson, L; Lundsröm, M.; Jass, J., Biosensors and Bioelectronics, 2000, 15, 31-41; Graff, A.; Winterhalter, M.; Meier, W., Langmuir, 2001, 17, 919-923; Liley, M.; Bouvier, J.; Vogel, H. J., Coll. Inter. Sci., 1997, 194, 53-58; Naumann, R.; Schmidt, E. X.; Jonczyk, A.; Fendler, K.; Kadenback, B.; Liebermann, T.; Offenhäusser, A.; Knoll, W., Biosensors and Bioelectronics, 1999, 14, 651-662).

Supported lipid monolayers, bilayers and multilayers can be self-assembled by fusion of fluid, unilamellar vesicles, an important issue for commercial application, onto a variety of optically or electrically active substrates. Furthermore, the recent development of micro-patterning techniques to modify planar, substrate supported thin films, including supported lipid bilayers, adds promise to the potential of biochips with parallel arrays of sensing elements for high throughput biological or pharmaceutical screening or sensing (Hovis, J. S.; Boxer, S. B., Langmuir, 2000, 16(3), 894-897; Hovis, J. S.; Boxer, S. B., Langmuir, 2001, 17(11), 3400-3405; Kam, L.; Boxer, S. G., J. Am. Chem. Soc., 2000, 122, 12901-12902; Toby, A.; Jenkins, A.; Boden, N.; Bushby, R. J.; Evans, S. D.; Knowles, P. F.; Miles, R. E.; Ogier, S. D.; Schönherr, H.; Vancso, J. G., J. Am. Chem. Soc., 1999, 121, 5271-5280; Groves, J. T.; Mahal, L. K.; Bertozzi, C. R., Langmuir, 2001; Srinivasan, M. P.; Ratto, T. V.; Stroeve, P.; Longo, M. L., Langmuir, 2001, 17, 7951-7954; Morigaki, K.; Baumgart, T.; Offenhäusser, A.; Knoll, W., Angew. Chem., Int. Ed., 2001, 40, 172).

The key problem associated with implementing lipid structures in commercial molecular devise applications is the inherent lack of stability that arises from the exclusively non-covalent forces that are responsible for lipid lamellar assembly. As a result, partial or complete lamellar-structure loss is realized upon exposure to surfactants, organics, or removal of the film from aqueous environments. Finite aqueous lifetimes have also been observed, and lipid layer damage can occur upon fluid exchange, in the presence of soluble lipophilic proteins, or upon pH or temperature changes (Hui, S. W.; Viswanathan, R.; Zasadzinski, J. A.; Israelachvili, J. N., Biophys. J., 1995, 68, 171-178; Winger, T. M.; Ludovice, P. J.; Chaikof, E. L., Langmuir, 1999, 15, 3866-3874). These shortcomings prevent washing and reusing of a biosensor and seriously compromise the storage/shelf-life, reliability, and thus applicability of the device.

Covalently bound self-assembled monolayers (SAMS) featuring oligo(ethylene glycol) (Yang, Z.; Galloway, J. A.; Yu, H., Langmuir, 1999, 15); or other protein adsorption resistant headgroups (Chapman, R. G.; Ostuni, E.; Takayama, S.; Holmlin, R. E.; Yan, L.; Whitesides, G. M., J. Am. Chem. Soc., 2000, 122, 8303-8304) address the stability issue of biosensor coatings but are not without shortcomings, including an increased difficulty in functionalizing these films with water-soluble proteins in a well-defined manner, and not providing a suitable environment for transmembrane receptor proteins. Therefore, interest in stabilizing lipid films on solid supports continues to receive scientific attention.

An alternate method for incorporating phosphorylcholine groups into a substrate supported polymer film is copolymer synthesis followed by direct grafting to the substrate surface (Murphy, E. F.; Lu, J. R.; Lewis, A. L.; Brewer, J.; Russell, J.; Stratford, P., Macromolecules, 2000, 33, 4545). However, the molecular architecture of this assembly is more difficult to control than that of a lipid-based film, and is not amenable to functionalization with transmembrane proteins (Murphy, E. F.; Lu, J. R.; Lewis, A. L.; Brewer, J.; Russell. J.; Stratford, P., Macromolecules, 2000, 33, 4545; Sackman, E., Science, 1996, 271, 43; Watts, T. H.; Gaub, H. E.; McConnell, H. M., Nature, 1986, 320, 179; McConnell, H. M.; Watts, T. H.; Weis, R. M.; Brian, A. A., Biochim. Biophys. Acta, 1986, 864, 95; Salafsky, J.; Groves, J. T.; Boxer, S. G., Biochemistry, 1996, 35, 14773; Brian, A. A.; McConnell, H. M., Proc. Natl. Acad. Sci., 1984, 81, 6159).

Although the results achieved using supported lipid membranes as sensor coatings have been encouraging with respect to protein resistance, these structures lack the chemical and thermal stability required for technological implementation (e.g. as a non-fouling coating for a reusable biosensor). This is because the low molecular mass lipids in the bilayer are self-organized by relatively weak, noncovalent forces that are insufficient to maintain the bilayer structure when the membrane is, for example, removed from water.

Strategies employed to stabilize planar lipid structures under water include:
i) incorporation of template molecules, covalently attached either directly to the substrate or to a thin hydrophilic polymer, around which free lipids self-organize to form a bilayer (Duschl, C.; Liley, M.; Corradin, G.; Vogel, H., Biophys. J., 1994, 67, 1229; Yang, Z.; Yu, H., Langmuir, 1999, 15, 1731; Bunjes, N.; Schmidt, E. K.; Jonczyk, A.; Rippmann, F.; Beyer, D.; Ringsdorf, H.; Graber, P.; Knoll, W.; Naumann, R., Langmuir, 1997, 13, 6188) and
ii) derivatization of a metal or silica surface with an alkyl self-assembled monolayer, followed by deposition of a lipid monolayer, creating a hybrid bilayer (Plant, A. L., Langmuir, 1999, 15, 5128; Stelzle, M.; Weissmuller, G.; Sackman, E. J., Phys. Chem., 1993, 97, 2974; Song, X. D.; Swanson, B. I., Anal. Chem., 1999, 71, 2097; Parikh, A. N.; Beers, J. D.; Shreve, A. P.; Swanson, B. I., Langmuir, 1999, 15, 5369; Fischer, B.; Heyn, S. P.; Egger, M.; Gaub, H. E., Langmuir, 1993, 9, 136; Meuse, C. W.; Krueger, S.; Majkrzak, C. F.; Dura, J. A.; Fu, J.; Connor, J. T.; Plant, A. L., Biophys. J., 1998, 74, 1388). Both strategies increase the stability of the structure in water while maintaining some degree of lateral lipid mobility. However, the integrity of these structures is compromised by lipid loss upon exposure to harsher environments, such as organic solvents, surfactant solutions, or transfer across the water/air interface.

A considerable body of work has shown that the stability and permeability of lipid bilayer vesicles (liposomes) can be significantly altered by polymerization of lipids containing reactive moieties (O'Brien, D. F.; Armitage, B.; Benedicto, A.; Bennett, D.; Lamparski, H. G.; Lee, Y. S.; Srisiri W.; Sisson, T. M., Acc. Chem. Res., 1998, 31, 861; Regen, S. L.; Singh, A.; Oehme, G.; Singh, M. J., Amer. Chem. Soc., 1982, 104; 791; Sisson, T. M.; Lamparski, H. G.; Kolchens, S.; Elyadi, A.; O'Brien, D. F., Macromolecules, 1996, 29, 8321). For example, unilamellar vesicles composed of bis-substituted lipids can be polymerized to form cross-linked vesicles that are insoluble in surfactant solutions and organic solvents (Sisson, T. M.; Lamparski, H. G.; Kolchens, S.; Elyadi, A.; O'Brien, D. F., Macromolecules, 1996, 29, 8321).

Several groups have prepared polymerized, multilamellar supported lipid films composed of commonly used diacetylenic PC lipids which can be stabilized by UV photopolymerization (Hayward, J.; Chapman, D., Biomaterials, 1984, 5, 135; Chapman, D., Langmuir, 1993, 9, 39; 21). However, to be efficiently polymerized, these lipids must be in the solid analogous phase (L_{β}), which is incompatible with the self-assembly methods of the present invention and does not produce a high percentage of monomer to polymer conversion (Hayward, J.; Chapman, D., Biomaterials, 1984, 5, 135; Chapman, D., Langmuir, 1993, 9, 39; Albrecht, O.; Johnston, D. S.; Villayerde, C.; Chapman, D., Biochim. Biophys. Acta, 1982, 687, 165; Binder, H.; Anikin, A.; Kohlstrunk, B. J., Phys. Chem., 1999, 103, 450-460).

At least two research groups have used the polymerization strategy to stabilize lipid mono- and bilayers on solid supports. Regen and coworkers adsorbed films of mono- and di-acrylate functionalized lipids on poly(ethylene), followed by UV-photo-polymerization to form a supported polymerized lipid film of near monolayer thickness (Regen, S. L.: Kirszensztejn, P.; Singh, A., Macromolecules, 1983, 16, 338; Foltynowicz, Z.; Yamaguchi, K.; Czajka, B,. Regen, S. L., Macromolecules, 1985, 18, 1394). Their water contact angle data were indicative of a surface more hydrophobic than expected for a uniform array of PC groups, suggesting incomplete coverage and/or significant film disorder. However, the analytical tools (e.g. atomic force microscopy) needed to characterize film morphology and uniformity were not available at that time.

More recently, Chaikof and coworkers formed a hybrid bilayer by fusing vesicles (Marra, K. G.; Winger, T. M.; Hanson, S. R.; Chaikof, E. L., Macromolecules, 1997; 30, 6483; Orban, J. M.; Faucher, K. M.: Dluhy, R. A.; Chaikof, E. L., Macromolecules, 2000, 33, 4205) composed of mono-acrylate lipids onto a support coated with an alkylsilane monolayer; in situ polymerization produced linear polymers in the upper leaflet of this structure. Although enhanced stability during extended incubation in water was observed, significant lipid desorption occurred when the assembly was exposed to surfactant.

### SUMMARY OF THE INVENTION

It is therefore an object of the present invention to provide a lipid membrane which is a monolayer, bilayer, or multilayer that is self-assembled and stabilized at a solid surface.

It is another object of the present invention to provide a solid supported lipid film that is stable to transfer into air and exposure to surfactant solutions and organic solvents, yet retains the protein resistance characteristic of a fluid lipid bilayer.

It is yet another object of the present invention to include non-polymerizable amphiphilic molecules into a stabilized lipid membrane.

It is another object of the present invention to provide a stabilized lipid membrane that is an appropriate environment for reconstitution of a transmembrane protein and/or a water-soluble protein with retention of native protein structure and activity.

This and other objects have been achieved by the present invention the first embodiment which includes a method for the self-assembly and stabilization of a lipid membrane at a solid surface, comprising:
depositing a lipid monolayer or a lipid multilayer on a substrate, thereby obtaining a supported lipid monolayer or a supported lipid multilayer;
in situ polymerizing said supported lipid monolayer or said supported lipid multilayer, thereby obtaining a polymerized membrane.

### BRIEF DESCRIPTION OF DRAWINGS

FIG. 1 shows types of polymerizable groups that can be used in polymerizable lipids.

FIG. 2 shows examples of mono-substituted polymerizable lipids.

FIG. 3 shows examples of bis-substituted polymerizable lipids.

FIG. 4 shows examples of heterobifunctional polymerizable lipids.

FIG. 5 shows examples of polymerizable lipids that differ in the length of the lipid tail (can be 14 to 22 atoms) and the extent and location of unsaturation and/or branching in the lipid tail(s).

FIG. 6 shows some examples of the different types of head groups for polymerizable lipids.

FIG. 7 shows a schematic of the vesicle fusion process, forming a fluid supported lipid bilayer (1,2), followed by redox-initiated, radical polymerization (3) to produce a cross-linked bilayer (4).

FIG. 8 shows AFM images and linescans of a polymerized bis-SorbPC (redox) bilayer in air (left) and under water (center). On the right is an image of a region of the film that was deliberately damaged by repeated high force scanning.

FIG. 9 shows a bar graph of relative bovine serum albumin (BSA) adsorption to various films. The diagram illustrates the principle of total internal reflectance fluorescence (TIRF), which is used to measure adsorption of rhodamine labeled BSA molecules to the various films.

FIG. 10 shows TIRF generated BSA adsorption isotherms for various films on quartz substrates. The dried and rehydrated polymerized bis-SorbPC (redox) film demonstrates equivalent adsorption resistance at a BSA solution concentration of 1.5×10⁻⁵M.

FIG. 11 shows AFM images and linescans of a blank silicon substrate and a polymerized bis-SorbPC (redox) supported bilayer before and after exposure to a 15 μM BSA solution.

FIG. 12 shows an AFM image and a linescan of a dried, poly-diacetylenic PC lipid bilayer deposited by the Langmuir-Schaefer technique and polymerized by direct UV irradiation.

FIG. 13 shows show an AFM image and linescan of a dried, polymerized bis-SorbPC bilayer deposited by vesicle fusion and polymerized by direct UV irradiation.

FIG. 14 shows an AFM image of a dried, redox polymerized bilayer deposited by vesicle fusion and composed of 70% bis-SorbPC monomer and 30% non-polymerizable lipid DOPC.

FIG. 15 shows an AFM image and linescan of a dried, redox polymerized mono-SorbPC bilayer deposited by vesicle fusion.

FIG. 16 shows an AFM image and linescan of a dried, redox polymerized bis-DenPC bilayer deposited by vesicle fusion.

FIG. 17 shows an AFM image and linescan of a dried, redox polymerized DenSorbPC bilayer deposited by vesicle fusion.

FIG. 18 shows an AFM image (left) of biotin-BSA microcontact printed on a polymerized bis-SorbPC (redox) bilayer. The schematic on the right depicts binding of rhodamine labeled avidin to the patterned regions of biotin-BSA.

FIG. 19 shows an AFM image (left) of a UV polymerized, bis-SorbPC film patterned by microcontact printing. Printing removed portions of the supported fluid bilayer (dark stripes); UV polymerization then stabilized the remaining regions (light stripes). The illustration on the right depicts the procedure graphically.

FIG. 20 shows schematic of TIRF spectroscopy instrumentation, a) fused silica slide, b) quart prism, c) Teflon™ block and Viton™ o-ring, d) 4× microscope objective, e) long pass filter, f) PMT, g) lock-in amplifier, h) frequency generator, i) data acquisition computer, and j) reference photo diode.

FIG. 21 shows kinetic data for the UV polymerization of bis-SorbPC bilayers which was obtained by measuring the depletion of the monomer absorbance as a function of time. Inset: absorbance spectrum of the monomeric bis-SorbPC prior to polymerization.

FIG. 22 shows AFM images for (a) a dried bis-SorbPC bilayer film, and (b) the same film imaged under water to Example for UV polymerized filer. The film was deposited using the Langmuir-Schaefer method and polymerized with UV light.

FIG. 23 shows adsorption isotherms of FITC labeled BSA to a POPC monolayer, (a hydrophobic surface, solid line), a dehydrated bis-SorbPC bilayer (dashed line), and a POPC bilayer (dash-dot line). The lines through the data in each case represent the fitting the data to a Langmuir adsorption isotherm.

FIG. 24 shows the structures of several cyanine dyes that can be used for photosensitized polymerization of supported lipid films.

### DETAILED DESCRIPTION OF THE INVENTION

The present inventors have found a novel and successful strategy for the self-assembly and stabilization of a lipid bilayer, particularly a phospholipid bilayer, at a solid surface. After deposition of a lipid bilayer on a substrate, in situ polymerization of the supported bilayer produces a cross-linked membrane that is stable to transfer into air and exposure to surfactant solutions and organic solvents, yet retains the protein resistance characteristic of a fluid phosphatidylcholine (PC) bilayer.

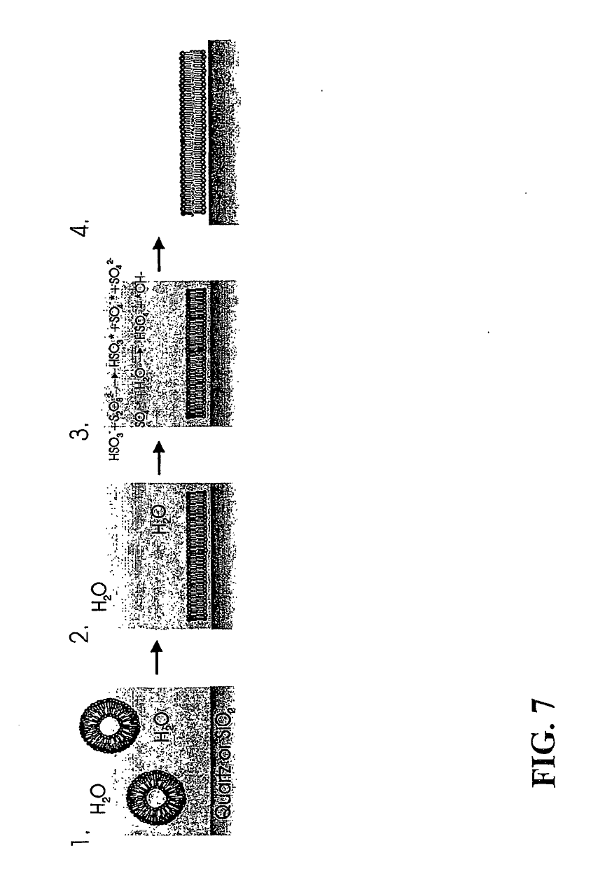

In a first embodiment of the present invention, a self-assembled, supported fluid membrane is formed by fusion of fluid, small unilamellar vesicles (SUVs) composed of a polymerizable lipid to a clean surface in a buffered aqueous solution or deionized water. The buffer solution or water used may also include added mono-, di-, or trivalent metal salts. Upon adsorption at a substrate/buffer solution interface, fluid bilayer SUVs spontaneously unroll to produce an extended, continuous lipid monolayer or bilayer (FIG. 7). In contrast, pre-polymerized phospholipid vesicles do not fuse to surfaces. The supported lipid film is then transferred to a redox polymerization medium to initiate polymerization without exposing the film to air.

Preferably, after incubating the film in the redox polymerization medium, the film is removed, cleaned, and dried under an inert gas atmosphere.

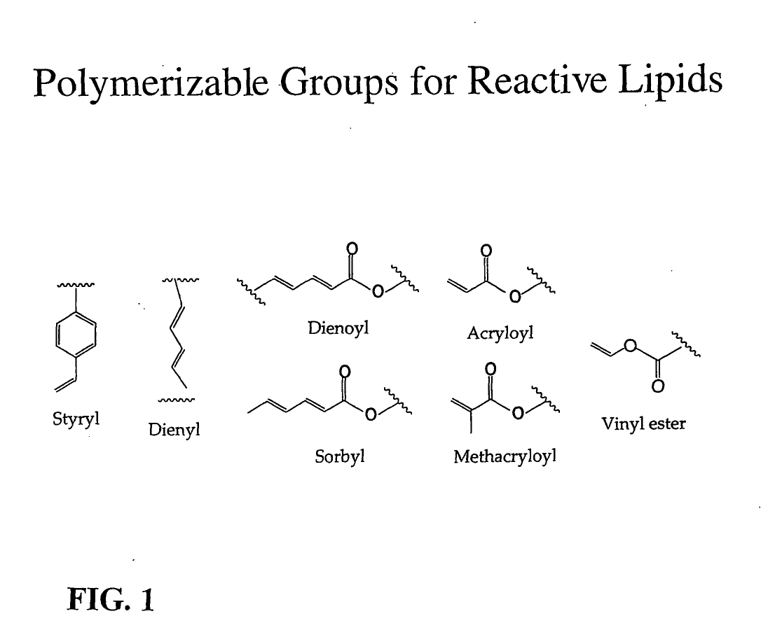

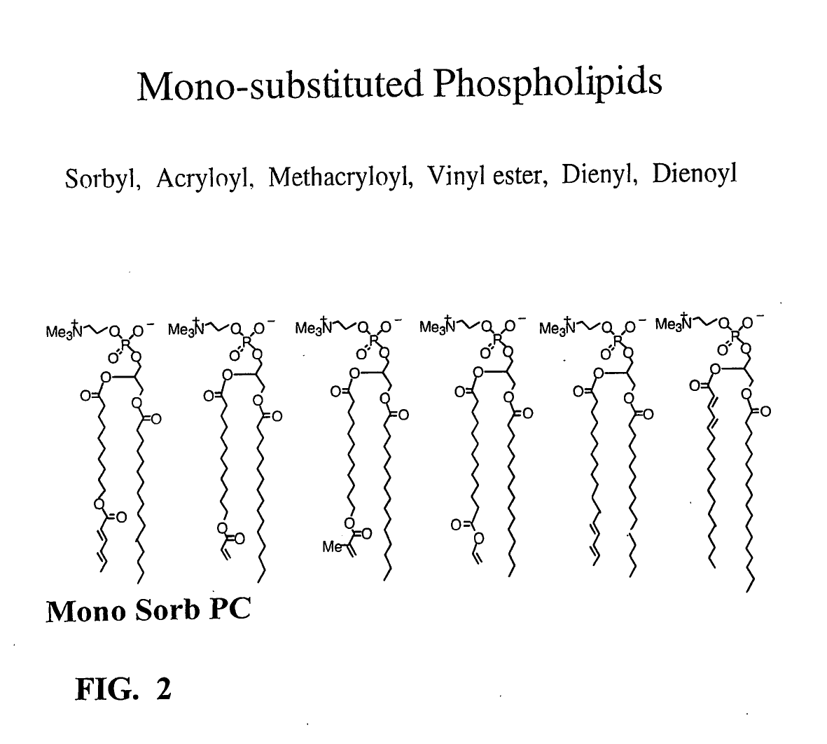

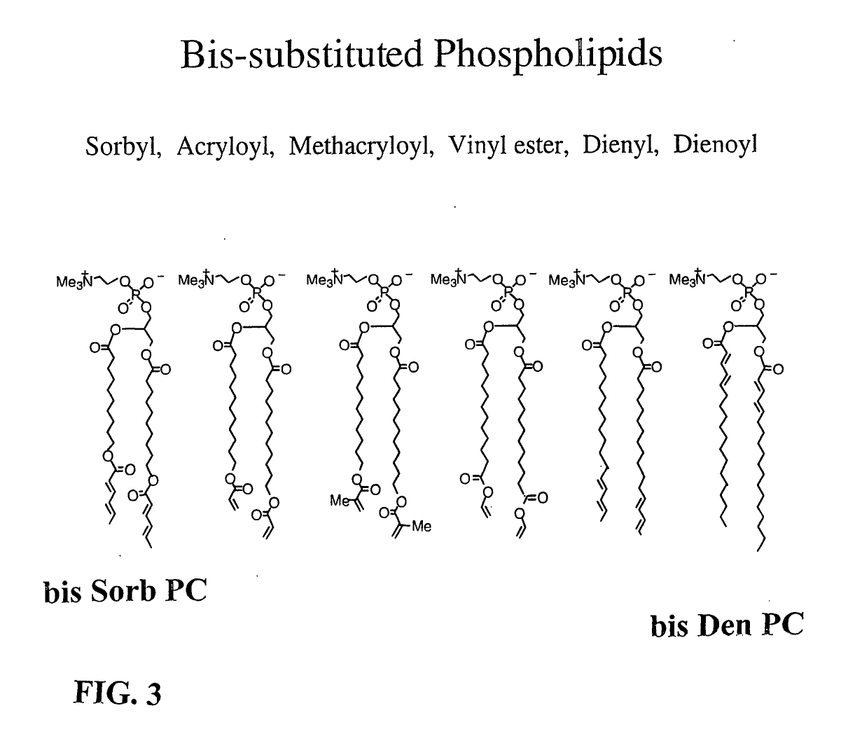

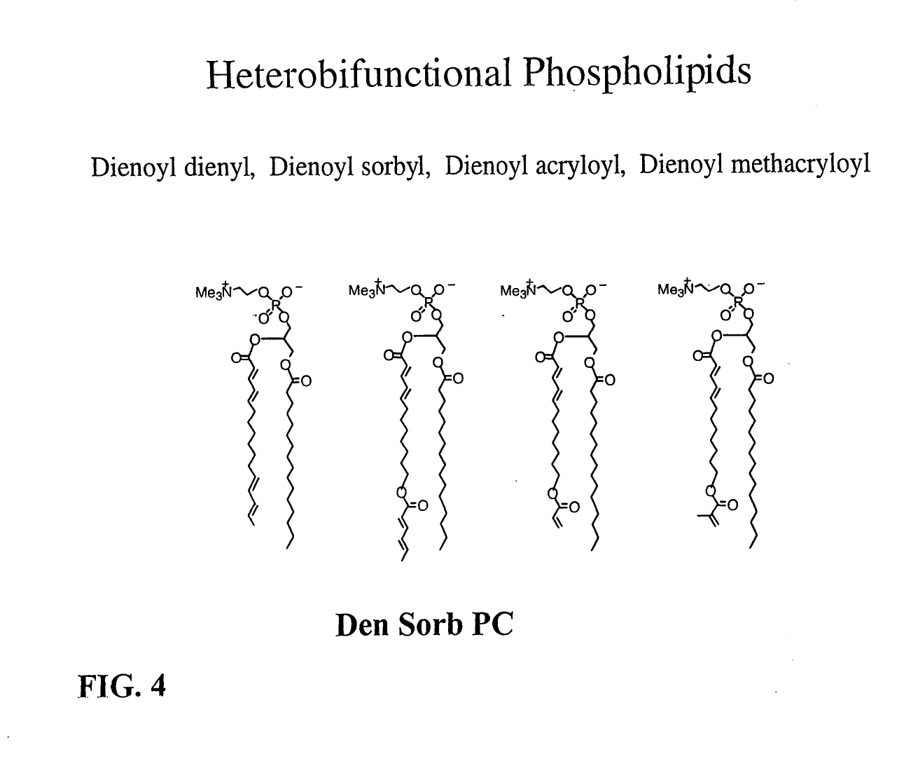

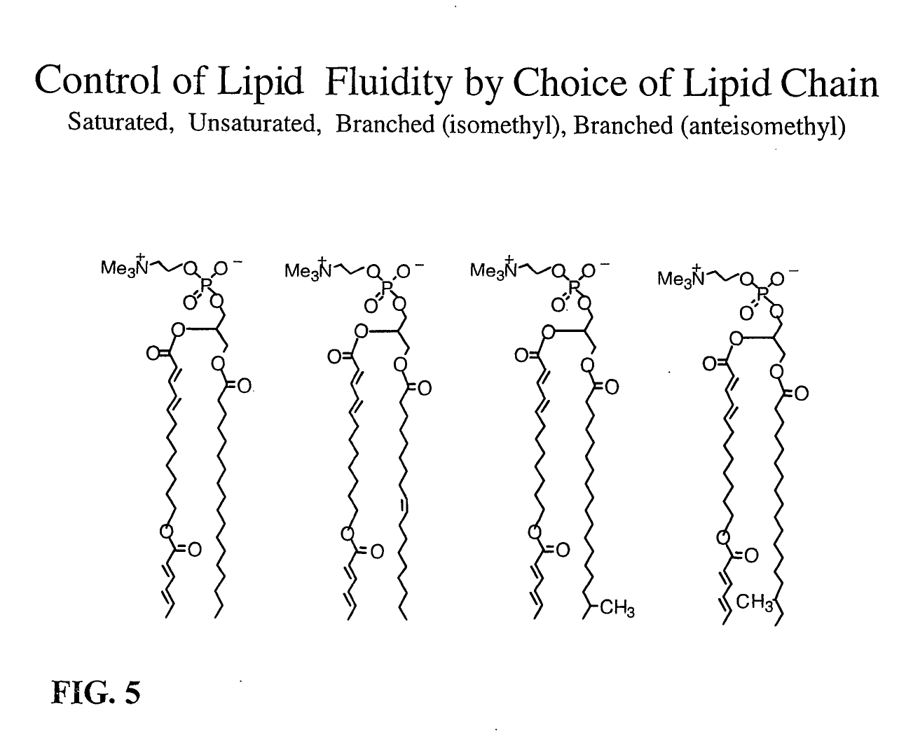

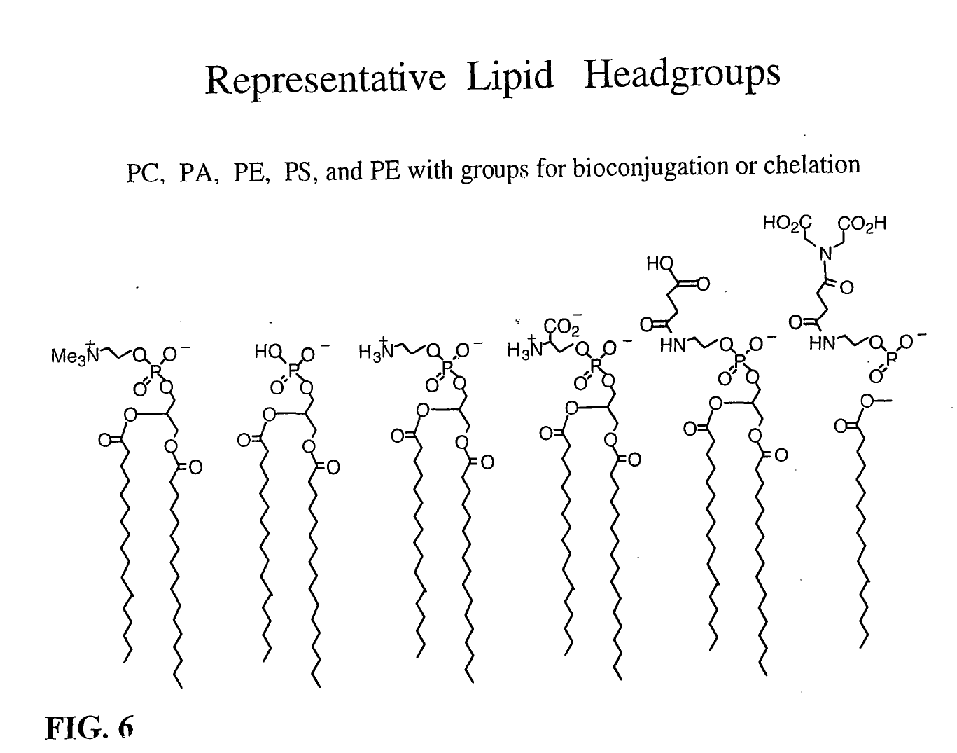

Polymerizable lipids that are useful for this invention include those which contain at least one of the polymerizable groups shown in FIG. 1, e.g. styryl, dienyl, dienoyl, sorbyl, acryloyl, methacryloyl, vinyl ester, among others. These groups can be located anywhere along the lipid tails as indicated by the examples shown in the following FIGS. 2-6. These examples include mono- and bis-substituted lipids, shown in FIGS. 2 and 3 respectively as phosphatidylcholines, which are ester lipids based on a glycerol backbone. The lipid backbone is not limited to glycerol, but could also be 1-aminopropane-2,3-diol, glutamic acid, aspartic acid, among others. In the lipid examples shown, the lipid tail is linked to the glycerol backbone through an ester bond. It is also possible to prepare similar polymerizable lipids with an ether bond. The polymerizable lipid can have two identical reactive groups in each lipid tail, or two different reactive groups in the same lipid tail, which are heterobifunctional lipids (FIG. 4). In order to control the bilayer fluidity, the main phase transition temperature of the lipid can be controlled through the choice of the length of the lipid tail from 14 to 22 atoms, and the extent and location of unsaturation and/or branching in the lipid tail(s) as shown in FIG. 5. The lipid head group can vary widely from phosphatidylcholine (PC), phosphatidic acid (PA), phosphatidylethanolamine (PE), and phosphatidylserine (PS), to PE-like lipids with associated groups such as succinate or chelating groups for the conjugation of functional compounds and metals to the lipid membrane surface (FIG. 6). Numerous other functionalized lipid headgroups (not shown) could be used, including headgroups terminated with thioethanol, maleimido, pyridyldithio, biotinyl, succinimidyl ester, sulfo succinimidyl ester, alkyl halide, or haloacetamide groups, as well as lipids functionalized with ethylene glycol-based oligomers and polymers.

Preferably, the lipid solutions are prepared as follows: Lipids from stock chloroform or benzene solutions or any other organic solvent in which the lipid is soluble are dried under a flowing inert gas such as Ar or N₂ to remove storage solvents. The lipids are then resuspended in deionized water (18 MΩ) or aqueous buffer. The lipid concentration is in the range of from 0.01 mg/l to 5 mg/l, and preferably in the order of 0.5 mg/ml. The lipid concentration includes all values and subvalues therebetween, especially including 0.05, 0.1, 0.5, 1, 1.5, 2, 2.5, 3, 3.5, 4 and 4.5 mg/l. The lipid suspension is then mechanically treated, for example, vortexed and sonicated to clarity, forming SUVs (eg., Barenholz, Y.; Gibbes, D.; Litman, B; Goll, J.; Thomson, T.; Carlson, F., Biochemistry, 1977, 16, 2806). Temperature control is preferably maintained at more than 10 degrees above the reported lipid transition temperature. The SUVS are preferably used within 30 minutes of preparation, more preferably within 20 minutes after preparation and most preferably within 10 minutes after preparation.

Other methods to prepare unilamellar vesicles include, but are not limited to, extrusion of lipids through porous membranes (eg., MacDonald, R.; MacDonald, R. I.; Menco, B.; Takeshita, K.; Subbarao, N.; Lan-rong, H., Biochimica et Biophysica Acta, 1991, 1061, 297) and surfactant dialysis (eg., Mimms, L. T.; Zampighi, G.; Nozaki, Y.; Tanford, C.; Reynolds, J. A., Biochemsitry, 1981, 20, 833). Both methods have been successfully used to prepare vesicles for subsequent use in preparation of supported fluid lipid bilayers by vesicle fusion (Cremer, P. S.; Boxer, S. G., J. Phys. Chem. B, 1999, 103, 2554; Puu, G.; Gustafson, I., Biochim. Biophys. Acta, 1997, 1327, 149; Noller, P.; Kiefer, H.; Jähnig, F., Biophysical J., 1995, 69, 1447.)

Briefly, extrusion involves resuspension of dried lipids in appropriate solutions, as described above. A repeated freeze, thaw cycle may or may not be applied to produce multilamellar vesicles before the suspension is repeatedly passed through a porous size exclusion membrane. Unilamellar vesicles with a mean diameter ranging from 50 to 1000 nm are created depending on the size of the pores in the membrane used. The diameter includes all values and subvalues therebetween, especially including 100, 200, 300, 400, 500, 600, 700, 800 and 900 nm.

Surfactant dialysis, also known as detergent depletion, occurs when a suspension of lipid and detergent, (present together in aqueous solution at a concentration above the detergent critical micelle concentration) is dialyzed against another aqueous solution. The detergent passes through the dialysis membrane and is removed from the compartment containing the lipid, whereupon the remaining lipid spontaneously forms unilamellar vesicles.

Supported lipid films are prepared by vesicle fusion (FIG. 7), while avoiding exposure of the unpolymerized films to air, or excessive mechanical shocks. Care must be taken to avoid light exposure to polymerizable lipids or lipid films. Thus, they are handled under yellow light. Vesicle fusion to solid supports is a well documented, and commonly used practice to form substrate supported fluid lipid bilayers. The rate of fusion and bilayer spreading is controlled by a ‘subtle balance’ of van der Waals, electrostatic, hydration, and steric forces, but it is of yet, poorly understood what relation these forces play in the process. (Cremer, P. S.; Boxer, S. G., J. Phys. Chem. B, 1999, 103, 2554). Vesicle fusion of liposomes containing no net charge (eg., phosphorylcholine headgroups) to glass supports has no observable pH dependence over a range of 2.5-12.3, nor a dependency upon ionic strength. (Cremer, P. S.; Boxer, S. G., J. Phys. Chem. B 1999, 103, 2554) The concentration of suspended vesicles in the aqueous solution plays a role in the kinetics of bilayer formation, but not in the physical structure of the final supported film. Preferably, a concentration is used that will allow timely formation of the bilayer, for example, on oxidized silicon, this is a lipid concentration of typically greater than 0.1 mg/ml, but it is noted that lower and higher concentrations will produce supported films. Preferably, the lipid concentration is greater than 0.5 mg/ml, particularly preferably greater than 1 mg/ml.

Alternatively lipid films can be formed using standard Langmuir-Schaefer techniques according to reference procedures (Morigaki, K.; Baumgart, T.; Offenhausser, A.; Knoll, W., Angew. Chem., Int. Ed., 2001, 40, 172).

The substrate surface is preferably cleaned using a plasma cleaner, a sonicator, UV light, an organic solvent such as alcohol or chloroform, a strong acid solution such as a pirhana solution, an aqueous or alcoholic solution of H₂O₂, or an aqueous or alcoholic solution of a hydroxide of an alkali earth metal, such as NaOH or KOH. Surfaces are preferably used within 1 hours of cleansing, preferably within 30 minutes, more preferably within 20 minutes and most preferably within 10 minutes.

Preferred surfaces of the solid support are silicon dioxide (SiO₂), silicon oxide (SiOₓ), a noble metal such as gold, silver, platinum; mica, a polymer surface, a thin polymer film coated substrate, indium-tin oxide (ITO), tin oxide, indium oxide and silicon. The surface can be planar or non-planar.

A preferred buffer solution is phosphate. A preferred pH of the buffer solution is 7.4. The pH of the solution can be any value from pH 5.6 to pH 8. The buffer can be prepared with any chemical compound having a pKₐ between 5 and 9. The solution can also contain added metal salts, including monovalent, divalent, and trivalent metal salts. Preferred concentrations are from 0 up to and including 500 mM. The concentration includes all values and subvalues therebetween, especially including 1, 10, 50, 100, 150, 200, 250, 300, 350, 400 and 450 mM.

The redox initiator system is preferably K₂S₂O₈/NaHSO₃ (FIG. 7). A preferred concentration of the persulfate is 1 mM to 1 M. The concentration of the persulfate includes all values and subvalues therebetween, especially including 5, 10, 50, 100, 200, 300, 400, 500, 600, 700, 800 and 900 mM. A preferred oxidant to reductant ratio is from 1:1 to 1:10. The oxidant to reductant ratio includes all values and subvalues therebetween, especially including 1:2, 1:3, 1:4, 1:5, 1:6, 1:7, 1:8 and 1:9. At all concentrations above 0.01M, regardless of the oxidant/reductant ratios used, polymerized lipid films are indistinguishable by AFM and ellipsometry.

Many other redox initiator systems can also be used. Examples of suitable oxidants include H₂O₂, KrBrO₃, CuCl, Cs(SO₄)₂. Examples of suitable reductants include L-cysteine, H₂N₂H₂, ascorbic acid, HCOOH, R₃N (where R is hydrogen or any group that contains carbon), and salts of Fe⁺², Ag⁺, SO₃⁻. In all cases, a preferred concentration of the oxidant is 1 mM to 1 M. The oxidant concentration includes all values and subvalues therebetween, especially including 5, 10, 50, 100, 200, 300, 400, 500, 600, 700, 800 and 900 mM. A preferred oxidant to reductant ratio is from 1:1 and 1:10. The oxidant to reductant ratio includes all values and subvalues therebetween, especially including 1:2, 1:3, 1:4, 1:5, 1:6, 1:7, 1:8 and 1:9.

In a preferred case oxygen is excluded by deoxygenating the reaction solutions with a flowing inert gas such as Ar or N₂. The gas flow can occur before the polymerization and can continue throughout the polymerization.

The film is preferably incubated in the redox polymerization medium for 1 minute to five hours. The incubation time includes all values and subvalues therebetween, especially including 5 min, 10 min., 20 min., 40 min., 60 min., 80 min., 100 min., 120 min., 140 min., 160 min., 180 min., 200 min., 220 min., 240 min., 260 min. and 280 min.

After incubation, the film is preferably rinsed with water or an aqueous solution of an organic solvent, such as a lower alcohol in water. Water is preferably purified to 18 MOhms and made organic free. The inert gas for drying is preferably Ar or N₂.

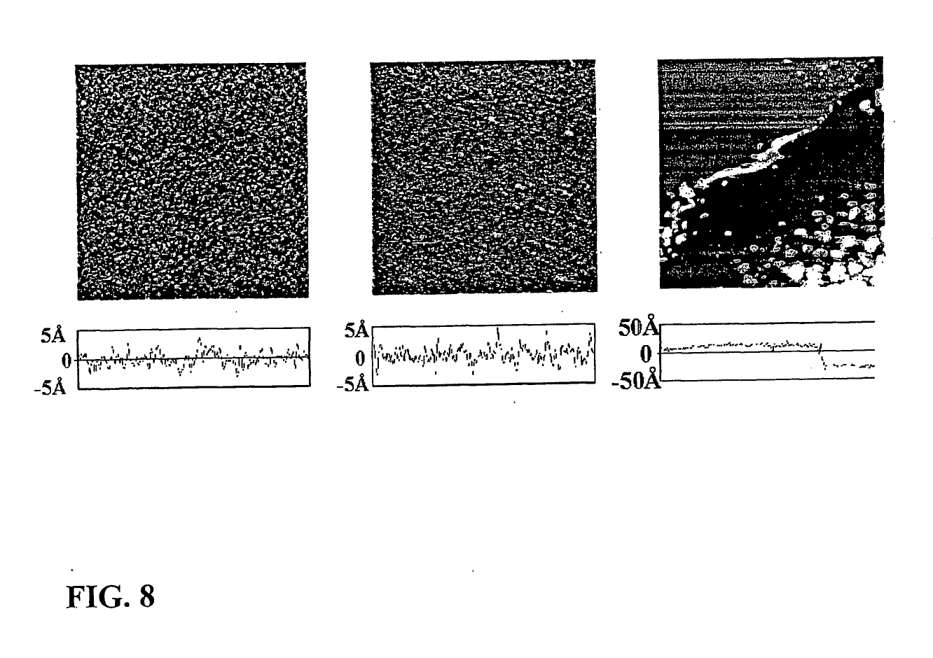

Polymerized lipid bilayers have been prepared from bis-SorbPC on SiO₂ (FIG. 3). Redox generated radical polymerization resulted in dried bilayer films of bis-SorbPC (hereinafter referred to as “bis-SorbPC(redox)”) with a thickness of about 45 Å and a sessile water contact angle of about 32 degrees. The contact angle of 32 degrees for the bis-SorbPC(redox) film is very similar to the value of 28 degrees reported by Cooper et al. (Tegoulia, V.; Rao, W.; Kalamber, A.; Rabolt, J.; Cooper, S., Langmuir, 2001, 17, 4396), for a phosphorylcholine terminated SAM film on gold. This is strong evidence that the polymeric bis-SorbPC (redox) bilayer film remains structurally similar to a fluid bilayer, presenting polar, zwitterionic head groups at the film/air interface. The images in FIG. 8, acquired using tapping mode atomic force microscopy (AFM), show that the polymerized bilayer surface is very smooth. The root mean square roughness of the image acquired in air (left) is 1.25 Å, which is comparable to the roughness of the bare silicon substrate (rms of 1.1 to 1.3 Å). No discernible change in film morphology or surface roughness was observed when a previously dried region of a film was re-imaged under water (center image). The bilayer surface morphology was surprisingly uniform; the left and center images are representative of images acquired at numerous locations over a ca. 1 cm² sample area. No topographical features greater than 1 nm in height (peak-to-peak) were detected. Thus any defects at which bare substrate was exposed were too narrow to image by AFM.

Polymerized bilayers can be deliberately damaged by repeated, high force scanning (right image in FIG. 8); a line scan across a film containing such a ‘trough’ yielded an apparent film thickness of 39-47 Å, consistent with the ellipsometry data.

The phospholipid bilayer of the present invention is stable in organic solvents, particularly to chlorinated hydrocarbons such as chloroform, ethers such as tetrahydrofuran, alcohols such as methanol and ethanol, sulfur-containing solvents such as DMSO, ketones such as acetone, and aromatic solvents such as toluene, benzene. It is also stable when exposed to solutions of anionic, cationic, non-ionic, or polymeric surfactants. Exposure to organic solvents or surfactant solutions does not alter the ellipsometric thickness or the AFM images of the stabilized bilayers.

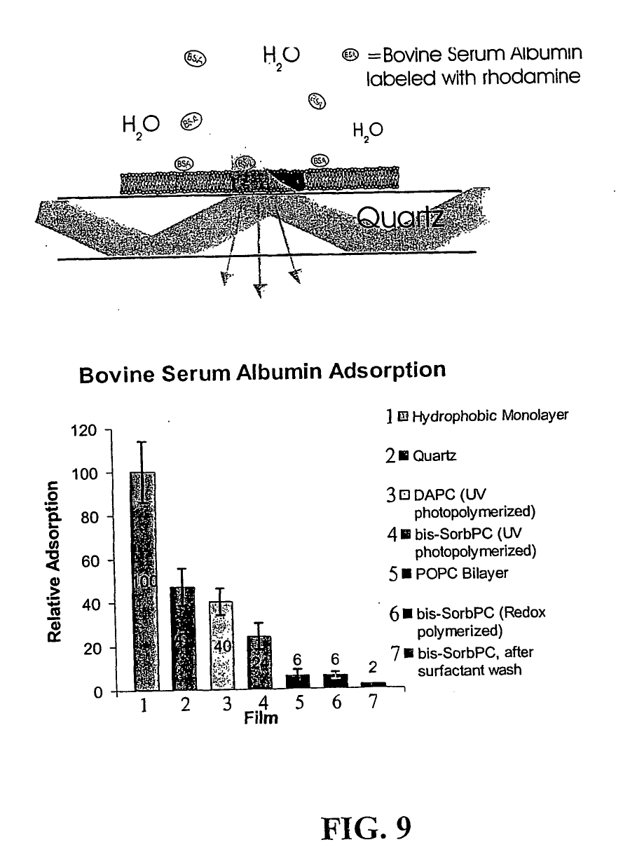

The polymerized phospholipid bilayer according to the first embodiment of the present invention exhibits resistance to nonspecific protein adsorption even after polymerization of the hydrophobic tails of the lipid monomers, which provides evidence that the “headgroup out” structure of the bilayer is preserved after drying and rehydration. In fact, the resistance of the bis-SorbPC bilayer of the present invention for BSA (bovine serum albumin) is comparable to that of a fluid 1-palmitoyl-2-oleolyl-PC(POPC) bilayer as demonstrated by the comparative data shown in FIGS. 9-11.

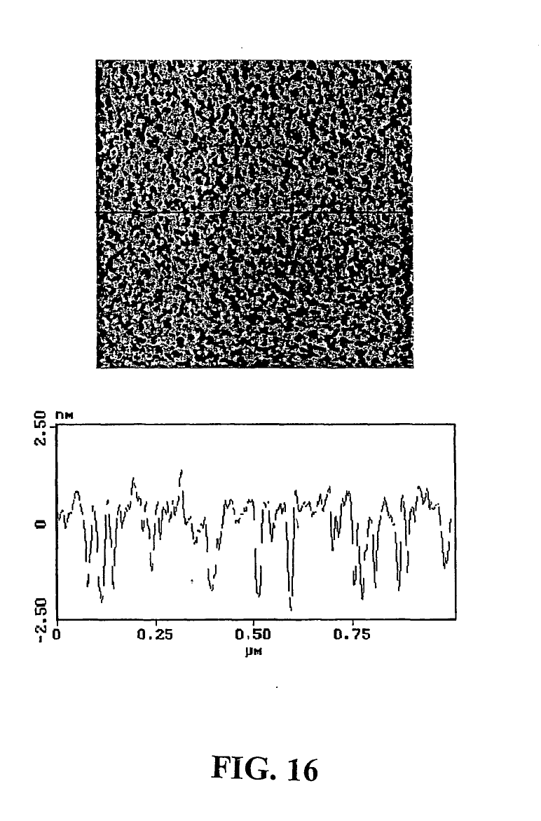

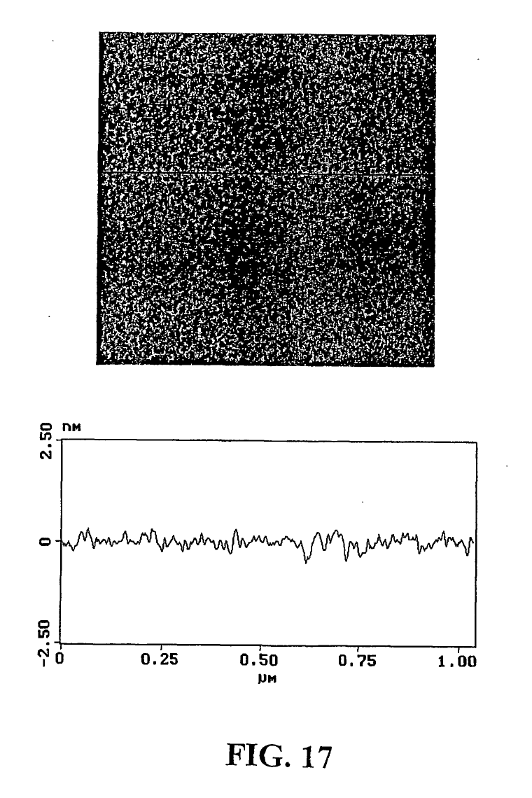

Lipids in addition to bis-SorbPC have also been used in the present invention. The above described vesicle fusion, Langmuir-Schaefer, redox-initiated polymerization, or the UV polymerization methods may be used as described above. Supported lipid bilayers have been prepared using both bis-DenPC (FIG. 3) and DenSorbPC (FIG. 4). A DenSorbPC lipid bilayer formed by vesicle fusion and redox polymerization was indistinguishable from a bilayer of bis-SorbPC (redox) as judged by AFM (FIG. 17). Ellipsometric thickness were nearly equivalent as well, and upon bath sonication in surfactant, only a minute thickness change was observed. The redox polymerization of bis-DenPC lipids after vesicle fusion to form a supported bilayer resulted in an ellipsometric thickness of 52 Å, however upon bath sonication in the surfactant Triton-X-100, a significant decrease in film thickness was recorded. AFM images (FIG. 16) of the film surface reveal the surface to contain defects located uniformly throughout the film. Examination of the line scans suggest that the defects do not reach the substrate but instead are losses of lipid from the outer monolayer of the film since the depth of the holes is less than 3 nm. These differences in film structure arise from differences in the location of the polymerizable moiety in the lipid.

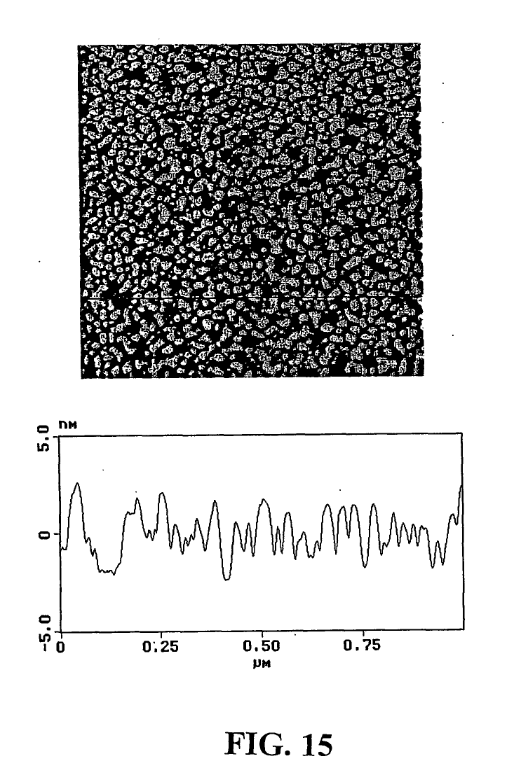

Another example, shown in FIG. 15, is an AFM image of a dried, redox-polymerized bilayer composed of mono-SorbPC (FIG. 2) that was deposited by vesicle fusion. The incomplete structure of the film is ascribed to the absence of cross-linking, which is precluded when using mono-functionalized lipid at a mole fraction of 1.

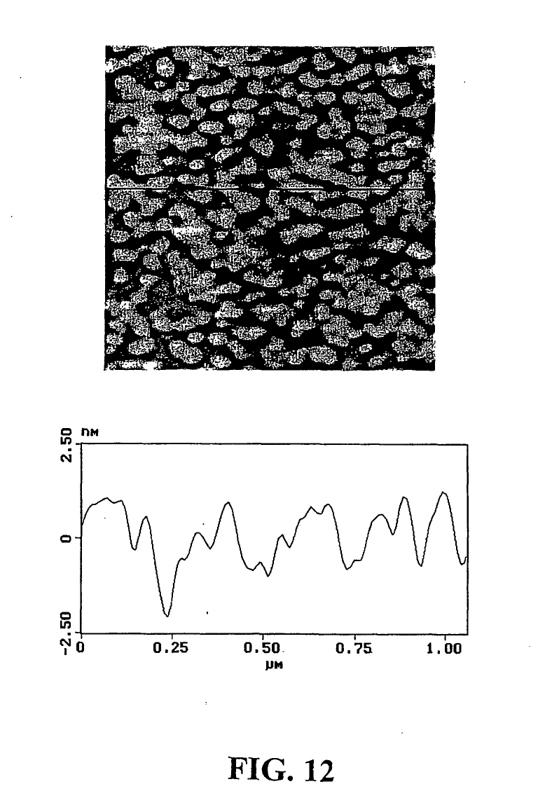

For comparison, protein adsorption data to other surfaces, including bare silica and a hydrophobic monolayer of arachidic acid, are also shown in FIGS. 9-11. In addition, data are presented for a supported bilayer formed from a commercially available diacetylenic PC lipid (1,2-bis(10,12-tricosadiynyl)-sn-glycero-3-phosphocholine; Avanti Polar Lipids) that was deposited by the Langmuir-Schaefer technique and photopolymerized using UV light. This type of bilayer exhibits considerably more protein adsorption than a bis-SorbPC (redox) bilayer (comparison data shown in FIG. 9). The difference is attributable to the large number of defects in the diacetylenic PC lipid bilayer (AFM image shown in FIG. 12). Thus clearly the performance of the present invention is superior to existing technology.

In a second embodiment of the present invention, the lipid bilayers are prepared by the vesicle fusion method, or using Langmuir-Blodgett and/or Langmuir-Schaefer technique, and polymerized by direct photo-irradiation with V, visible or near infrared light or γ-rays. The rays can be polarized or unpolarized.

Preferred polymerizable lipids are those described above in the first embodiment and shown in FIGS. 1-6.

Direct UV polymerization is performed by exposing the lipid bilayer films to UV radiation at a wavelength of between 230 and 350 nm, preferably at 260 nm and more preferably at 254 μm. The wavelength includes all values and subvalues therebetween, especially including 240, 250, 260, 270, 280, 290, 300, 310, 320, 330, and 340 nm. The UV light may be polarized or unpolarized.

Both, direct UV-photoinitiation and redox-initiated radical polymerization stabilize films of the lipid to surfactant dissolution suggesting the formation of a cross-linked polymeric network. However, a difference in the degrees of polymerization occurs for the two initiation methods. For example, redox initiated polymers of bis-SorbPC are larger (Xn approx 50+) than UV photopolymerized polymers (Xn<10), which suggests different propagation mechanisms for the polymerizations.

The UV-irradiation proceeds for 1 second to 1 hour at photon fluxes ranging from 1×10¹³ to 1×10¹⁷ photons/second. The irradiation time includes all values and subvalues therebetween, especially including 5, 10, 20, 30, 40, 50, 60, 70, 80, 90, 100, 120, 140, 160, 180, 200, 220, 240, 260 and 280 seconds, 10 min., 15 min., 20 min., 25 min., 30 min., 35 min., 40 min., 45 min., 50 min., and 55 min. The photon flux includes all values and subvalues therebetween, especially including 5×10¹3, 1×10¹⁴, 5×10¹⁴, 1×10¹⁵, 5×10¹⁵, 1×10¹⁶ and 5×10¹⁶ photons/second.

The thickness of the bis-SorbPC (UV) films deposited by vesicle fusion and UV polymerized are about 29 Å and the surface is usually more hydrophobic than redox polymerized bis-SorbPC films (redox) with a contact angle of 52 degrees.

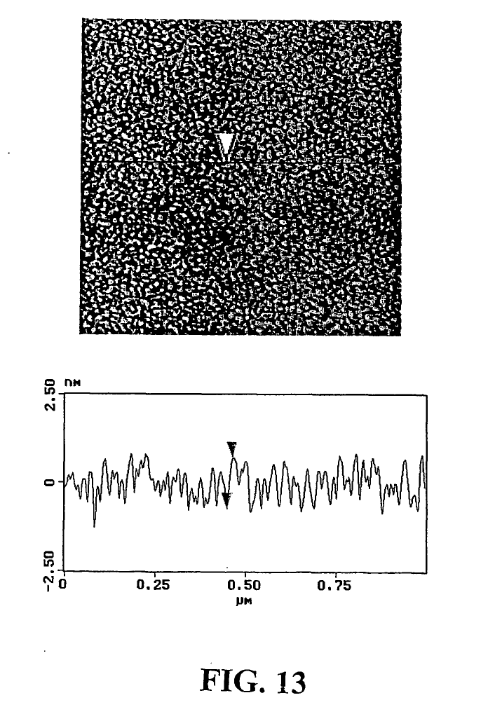

Furthermore, AFM images presented in FIG. 13 illustrate that by comparison to bis-SorbPC(redox) films (rms roughness of 0.15 nm), the UV polymerized films (bis-SorbPC(UV)) are much rougher (rms roughness=0.35 nm), and have discernable features or domains approximately 1.5 to 2 nm thick. These features are very uniformly distributed on the film surface. No regions were found on any of the UV polymerized film that were devoid of polymer film, or where the domains differed appreciably in size. The ellipsometric thickness, combined with the depth of the features suggest that they are likely regions of film where the surrounding lipid-polymer has been removed upon drying and rinsing and likely do not extend to the substrate because partial coverage of a 1.5 to 2 mm film would be inconsistent with the ellipsometric thickness of 29 Å.

The UV-polymerizations are usually not sensitive to the presence of oxygen, nor has the rate of polymerization a noticeable effect on the film properties. The rate of polymerization can be affected by altering the intensity of the light used to photopolymerize the film. UV-Vis spectroscopy of polymerized bilayers reveals an equivalent degree of conversion for both UV and redox-initiated polymerizations. The degree of conversion is >90%, preferably >95% and most preferably >99%. Because the polymerization by redox initiators and UV light produce the same polymer product, the difference in acyl-chain structure is not likely the reason for the difference in film properties. Evidence from protein adsorption studies on UV polymerized films before they are subjected to drying suggest that the polymerization does not significantly alter the structure of the film. Therefore, the defects appearing in the bis-SorbPC(UV) films may be due to a decrease in the stabilization of lower molecular weight polymer fragments produced by direct photopolymerization. Polymerizations are not monodisperse, therefore a range of molecular weights exist in the polymer film and it is possible that the smaller polymer fragment population accounts for the material lost upon drying. The fact that the UV polymerization resulted in the presence of any film after drying at all represents a significant increase in the stability of an unpolymerized fluid lipid film, which by comparison returned negligible ellipsometric thickness. AFM images of surfaces of unpolymerized fluid lipid films on silica were basically indistinguishable from images of a blank silica surface. This is consistent with the observation of several authors that lipid film loss and/or disruption to the lamellar structure occurs upon drying fluid supported phospholipid bilayers (Cremer, P. S., Boxer, S. G., J. Phys. Chem. B, 1999, 103, 2554).

The many variables under which lipid bilayers are polymerized by direct UV irradiation have not been exhaustively investigated. Considering the independence of the degree of polymerization observed in vesicles to temperature or polymerization rate, it is likely that the mechanism of polymerization for bis-SorbPC may limit the polymer product to low molecular weights. However, it is expected that other types of polymerizable lipids, such as those shown in FIGS. 1-6, may be converted by direct UV irradiation to polymer in higher yields than bis-SorbPC, resulting in lipid films of quality comparable to bis-SorbPC (redox). In addition, further optimization is anticipated by systematically varying other variables, such as irradiation time and photon flux.

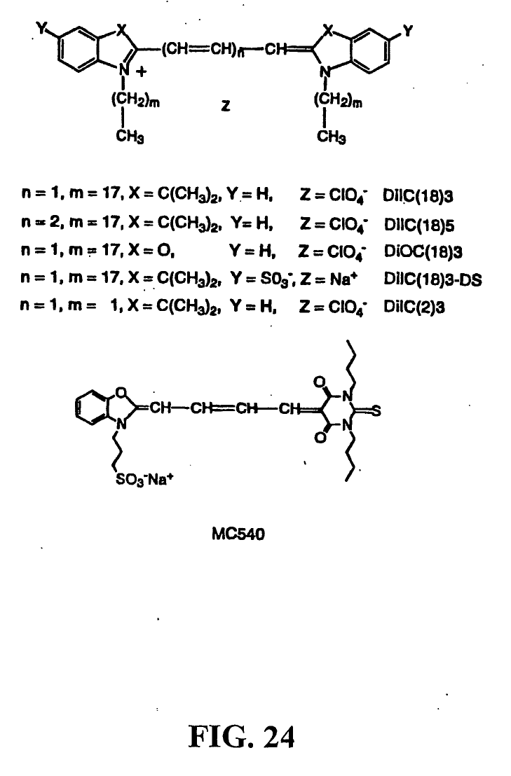

Lipid polymerization can also be initiated by a dye-sensitized process (Clapp, P. J.; B. A. Armitage, B. A.; O'Brien, D. F. Macromolecules, 1997, 29, 32). Here a membrane-bound cyanine dye that absorbs in the visible or near-infrared spectral regions is incorporated into the membrane. Irradiation at a wavelength at which the dye absorbs, in the presence of oxygen, is thought to generate hydroxyl radicals which initiate lipid polymerization. The dye can be added to the lipid solution either before or after formation of SUVs, prior to using the vesicles to perform vesicle fusion. For Langmuir-Blodgett or Langmuir-Schaefer deposition, the dye is added to the lipid before it is spread as a monolayer film on a Langmuir trough. The preferred molar ratio of lipid to dye ranges from 5:1 up to 30:1. The preferred pH range is 6.0 to 9.5. The preferred temperature is 15° C. to 45° C. The preferred wavelength of incident light is 350-800 nm. The irradiation proceeds for 1 second to 5 hours at preferred incident photon flux ranges from 0.036×10¹⁸ to 2×10¹⁸ photons/second. In the preferred method, ambient oxygen is present in the solution and the gas surrounding the solution. A number of different dyes can be used to initiate the polymerization of the types of lipids shown in FIGS. 1-6, including but not limited to the cyanine dyes shown in FIG. 24. Supported lipid membranes polymerized using the dye-sensitized process have been prepared in our laboratories, with results similar to that obtained using direct UV photopolymerization (described above). Further optimization of the dye-sensitized process is anticipated by systematically varying the numerous variables involved, including dye:lipid ratio, irradiation time and photon flux, type of dye used, type of lipid used, temperature, oxygen concentration, lipid film deposition method.

A third embodiment relates to the incorporation of non-polymerizable amphiphiles (e.g. surfactants or lipids) or any other molecule that will insert in the stabilized lipid membranes.

Phospholipid bilayer films according to the present invention may be formed using a mixture of polymerizable lipid and non-polymerizable lipid by the above described methods. The amount of non-polymerizable lipid in the mixture is in the range of from 0.01 to 50%, preferably not more than 30%, more preferably not more than 10% and most preferably not more than 2%. The amount of non-polymerizable lipid in the mixtures includes all values and subvalues therebetween, especially including 0.05, 0.1, 0.5, 1, 5, 10, 15, 20, 25, 30, 35, 40 and 45%.

The polymerizable lipid in these films can be any of the lipids or lipid types shown in FIGS. 1-6, and mixtures thereof, in any molar desired ratio. The above described vesicle fusion, Langmuir-Schaefer, redox-initiated polymerization, and light-driven (UV, visible, or near-infrared) methods may be used as described above to deposit and polymerize the polymerizable lipids in the membrane. In the preferred implementation, the non-polymerizable molecules are mixed with the polymerizable lipids prior to vesicle preparation. Vesicles composed of non-polymerizable molecules and polymerizable lipids are prepared and fused to appropriate substrates (as described above) to form supported lipid membranes that are subsequently polymerized. Alternately, the polymerized, supported lipid membrane is prepared and then a solution of non-polymerizable molecules is brought into contact with the membrane, which causes the non-polymerizable molecules to bind to and insert into the membrane.

The non-polymerizable molecules incorporated into the membrane are typically amphiphilic, e.g. a single-chain surfactant or a non-polymerizable lipid, that will bind to and associate with a membrane. The nature of the association reaction can be either non-covalent or covalent. Preferred non-polymerizable molecules are those which impart a functional property to the membrane, i.e. a surfactant or lipid bearing a headgroup that is functionally distinct from the headgroups on the polymerizable lipids in the membrane. Examples include single-chain and double-chain surfactants having anionic or cationic headgroups, headgroups functionalized with ethylene glycol-based oligomers and polymers, headgroups designed to chelate metal ions, headgroups functionalized with dyes that absorb light and/or emit fluorescence in the UV, visible, and/or near-infrared spectral regions, and headgroups designed to react with other molecules. Examples of the latter category include headgroups terminated with thioethanol, maleimido, pyridyldithio, biotinyl, succinimidyl ester, sulfo succinimidyl ester, alkyl halide, or haloacetamide groups.

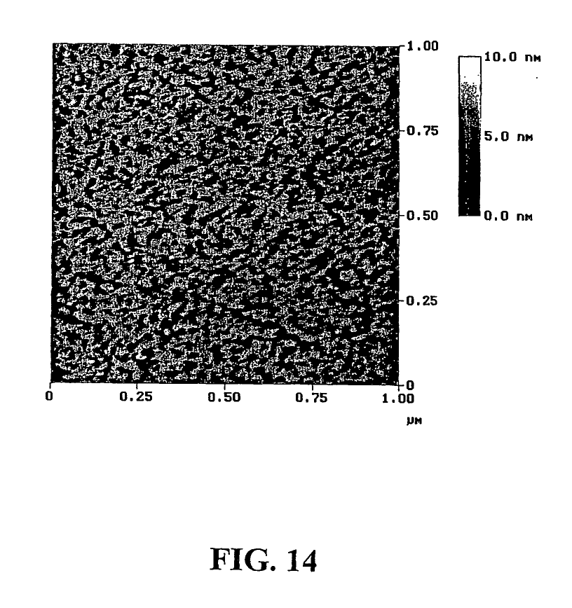

Another preferred implementation is the use of a non-polymerizable lipid, e.g. DOPC, mixed with a polymerizable lipid in a fluid vesicle or fluid supported lipid membrane. Upon polymerization, the non-polymerizable lipid will spatially segregate from the domains of polymerized lipid, forming a lipid membrane that contains spatially defined and distinct fluid and polymerized regions. An example is shown in FIG. 14, which shows an AFM image of a dried, redox polymerized, supported lipid bilayer deposited by vesicle fusion and composed of 70% bis-SorbPC and 30% non-polymerizable lipid DOPC.

In the fourth embodiment, supported phospholipid membranes are produced from mixtures of polymerizable lipids.

Phospholipid bilayer films according to the present invention may be formed using a mixture of different types of polymerizable lipids by the above described methods. The amount of each different type of lipid in the mixture is in the range of from 0.01 to 99.99%, including all values and subvalues therebetween.

The polymerizable lipids can be any of the lipids or lipid types shown in FIGS. 1-6, and mixtures thereof, in any molar desired ratio. The above described vesicle fusion, Langmuir-Schaefer, redox-initiated polymerization, and light-driven (UV, visible, or near-infrared) methods may be used to deposit and polymerize the membrane. In the preferred implementation, the different types of polymerizable lipids are mixed prior to vesicle preparation. Vesicles are then prepared and fused to appropriate substrates (as described above) to form supported lipid membranes that are subsequently polymerized.

In one preferred implementation, two types of polymerizable lipid molecules are present in the membrane. One type of lipid molecule, present in an amount less than 50%, preferably less than 30%, imparts a functional property to the membrane, i.e. it bears a headgroup that is functionally distinct from the headgroups on the other type of lipid in the membrane. Examples include functional lipids having anionic or cationic headgroups, having headgroups functionalized with ethylene glycol-based oligomers and polymers, having headgroups designed to chelate metal ions, or having headgroups designed to react with other molecules. Examples of the latter category include headgroups terminated with thioethanol, maleimido, pyridyldithio, biotinyl, succinimidyl ester, sulfo succinimidyl ester, alkyl halide, or haloacetamide groups. The second type of lipid molecule in the membrane is selected to be protein resistant, e.g. bis-SorbPC.

In another preferred implementation, the lipid membrane is composed of a mixture of complementary mono- and bisfunctionalized polymerizable lipids, e.g. mono-SorbPC and bis-SorbPC. Prior to polymerization, such lipids mix homogeneously in a fluid supported lipid membrane. Thus by varying the percentage of each, the density of cross-links in the polymerized bilayer is systematically adjusted. A lower cross-link density generates a more flexible yet still polymeric membrane. As long as the mole fraction of bis-substituted lipid exceeds 0.30±0.05, the polymerized bilayer will be still be cross-linked (Sisson, T. M.; Lamparski, H. G.; Kolchens, S.; Elyadi, A.; O'Brien, D. F., Macromolecules, 1996, 29, 8321).

The fifth embodiment of the present invention relates to the incorporation of membrane proteins into polymerized, supported lipid membranes. Incorporating protein receptors into a lipid membrane confers a biorecognition function to the membrane. Any membrane-associated protein can be incorporated into a polymerized, supported lipid membrane. In all cases, a preferred surface coverage of receptors is 0.1% to 50% of the coverage equivalent to a one monolayer of receptor. Receptor incorporation in an appropriate manner and orientation that maintains receptor activity can be assayed by the observation of the specific binding to complementary partners.

Membrane proteins, especially transmembrane proteins, require a lipid bilayer environment to preserve their structure and support their specific bioactivity. Reconstitution of transmembrane receptors into fluid, supported lipid membranes has been described (Z. Salamon, S. Cowell, E. Varga, H. I. Yamamura, V. J. Hruby and G. Tollin, Biophys. J., 2000, 79, 2463; J. D. Burgess, M. C. Rhoten and F. M. Hawkridge, Langmuir, 1998, 14, 2467; Heyse, S.; Ernst, O. P.; Dienes, Z.; Hofmann, K. P.; Vogel, H. Biochemistry, 1998, 37, 507; ReBieri, C.; Ernst, O. P.; Heyse, S.; Hofmann, K. P.; Vogel, H. Nature Biotechnology 1999, 17, 1105; Salamon, Z.; Tollin, G. Biophysical Journal, 1996, 71, 858; Salafsky, J.; Groves, J. T.; Boxer, S. G. Biochemistry 1996, 35, 14773; McConnell, H. M.; Watts, T. H.; Weis, R. M.; Brian, A. A. Biochim. Biophys. Acta, 1986, 864, 95; J. K. Cullison, F. M. Hawkridge, N. Nakashima, and S. Yoshikawa, Langmuir, 1994, 10, 877.) Typically, the receptor is solubilized in an aqueous buffer containing a surfactant above its critical micelle concentration (cmc). In the presence of fluid, unilamellar bilayer vesicles, removal of the surfactant from the solution (usually performed by dialysis) causes spontaneous insertion of the receptor into the bilayer, forming proteo-liposomes. Fusion of the proteo-liposomes to a solid support results in formation of a fluid, supported membrane containing receptor molecules (Salafsky, J.; Groves, J. T.; Boxer, S. G. Biochemistry 1996, 35, 14773). Retention of bioactivity for receptors reconstituted in this manner has been observed. However, with respect to use as a protein-resistant coating in, for example, a receptor-based biosensor, a fluid lipid bilayer lacks the required physical and chemical stability, such as removal from water. Polymerization of the lipid monomers to create a stabilized membrane, as described above, is a logical solution to this problem. To demonstrate the feasibility of this strategy, two different types of transmembrane receptors, cytochrome c oxidase (CcO) and human delta opioid receptor (d-OR) have been successfully reconstituted into polymerized, supported lipid membranes composed of bis-SorbPC, as described in the example section (see below).

The receptor is incorporated into the fluid, supported lipid membrane prior to carrying out polymerization step. There are two preferred methods for incorporation: surfactant dialysis followed by vesicle fusion (described briefly above and extensively in the literature; e.g. Salafsky, J.; Groves, J. T.; Boxer, S. G. Biochemistry 1996, 35, 14773), and insertion into a pre-formed supported membrane (Z. Salamon, S. Cowell, E. Varga, H. I. Yamamura, V. J. Hruby and G. Tollin, Biophys. J., 2000, 79, 2463). In the second method, SUVs composed of polymerizable lipids are fused on a support to form a fluid, supported lipid membrane that does not contain protein (as described above). Small aliquots of a concentrated solution of the receptor solubilized in a surfactant, e.g. octylglucoside, present above its cmc are added to the aqueous buffer solution in contact with the supported membrane. This dilutes the surfactant to a final concentration below its cmc, which results in spontaneous transfer of the receptor from the surfactant micelles to the supported membrane.

For both incorporation methods, there are many experimental variables that are specific to the type of transmembrane protein receptor being used. These variables include buffer concentration and pH, presence and concentration of added salts, protein concentration, lipid concentration, presence and concentration of charged lipid headgroups, surfactant concentration, and temperature. Values of these variables that are appropriate for incorporation of different transmembrane proteins into fluid supported lipid membranes have been published (Z. Salamon, S. Cowell, E. Varga, H. I. Yamamura, V. J. Hruby and G. Tollin, Biophys. J., 2000, 79, 2463; J. D. Burgess, M. C. Rhoten and F. M. Hawkridge, Langmuir, 1998, 14, 2467; Heyse, S.; Ernst, O. P.; Dienes, Z.; Hofmann, K. P.; Vogel, H., Biochemistry, 1998, 37, 507; ReBieri, C.; Ernst, O. P.; Heyse, S.; Hofmann, K. P.; Vogel, H., Nature Biotechnology 1999, 17, 1105; Salamon, Z.; Tollin, G., Biophys. J., 1996, 71, 858; Salafsky, J.; Groves, J. T.; Boxer, S. G., Biochemistry 1996, 35, 14773; McConnell, H. M.; Watts, T. H.; Weis, R. M.; Brian, A. A., Biochim. Biophys. Acta, 1986, 864, 95; J. K. Cullison, F. M. Hawkridge, N. Nakashima, and S. Yoshikawa, Langmuir, 1994, 10, 877.) Any of these conditions is also appropriate for transmembrane protein incorporation into a fluid supported membrane composed of polymerizable lipids. The difference between prior art and the present invention is the use of polymerizable lipids, such as those shown in FIGS. 1-6.

In addition to transmembrane proteins, the present invention is also advantageous for biofunctional presentation of water-soluble protein receptors. Attaching water-soluble proteins to the surface of a polymerized, supported lipid membrane confers a biorecognition function to the membrane. Any water-soluble protein can be attached to the supported membranes described herein, either before or after polymerization has been effected, but preferably after. In all cases, a preferred surface coverage of receptors is 0.1% to 100% of the coverage equivalent to a one monolayer of receptor. Attachment in an appropriate manner and orientation that maintains receptor activity can be assayed by the observation of the specific binding to complementary partners.

Numerous methods to attach water-soluble proteins to fluid and gel phase supported lipid bilayers have been described in the literature and are applicable to polymerized membranes described above as well. Three preferred methods are listed here: a) Biospecific binding between a protein ligand attached to a lipid headgroup in the membrane and a binding site for the ligand on the protein. For example, streptavidin can be attached to a supported lipid membrane that contains biotin-conjugated lipids (Edmiston, P. L.; Saavedra, S. S., J. Amer. Chem. Soc., 1998, 120, 1665). b) Covalent linkage between a functional group on the protein, e.g an amino or a thiol group, and a lipid bearing a reactive headgroup, e.g. a maleimido, pyridyldithio, or succinimidyl ester group. For example, yeast cytochrome c can be attached to a supported lipid membrane that contains pyridyldithio-conjugated lipids (Edmiston, P. L.; Saavedra, S. S., Biophys. J., 1998, 74, 999). c) Electrostatic adsorption of a charged protein to an oppositely charged membrane surface. For example, horse cytochrome c, which is positively charged at neutral pH, can be adsorbed to the surface of a lipid membrane that contains lipids having negatively charged headgroups such as phosphatidic acid and/or phosphatidylserine (Pachence, J. M.; Amador, S.; Maniara, G.; Vanderkooi, J.; Dutton, P. L.; Blasie, J. K., Biophys. J., 1990, 58, 379).

For any of these methods, there are many experimental variables that are specific to the type of protein being attached. These variables include buffer concentration and pH, presence and concentration of added salts, protein concentration, presence and concentration of reactive lipid headgroups, presence and concentration of charged lipid headgroups, and temperature. Any of the conditions used in published methods is also appropriate for protein attachment to a polymerized, supported lipid membrane. The difference between prior art and the present invention is the use of polymerizable lipids, such as those shown in FIGS. 1-6.

Regardless of the method and conditions used to insert or attach receptors into or to the surface of a fluid supported membrane composed of polymerizable lipids, the above described redox-initiated or light-driven (UV, visible, or near-infrared) methods may then be used to polymerize the membrane. A preferred strategy to preserve receptor activity during the polymerization step is pre-incubation of receptors with a solution of their respective ligand or agonist or antagonist at a concentration sufficiently high to saturate the binding sites on the receptors. Occupancy of the binding sites before polymerization provides a degree of steric ‘protection’ during the subsequent polymerization step. After polymerization is effected, the bound ligands can be dissociated from the receptors by standard methods to generate a membrane with unoccupied ligand binding sites.

The sixth embodiment of the present invention relates to the fabrication of spatially addressable, planar arrays of biomolecules. Techniques for such processes are currently being developed in numerous laboratories, based on projected applications for these arrays in rapid screening assays and multianalyte biosensors. For example, a method to generate an array of protein molecules adsorbed to a substrate using microcontact printing is disclosed in Bernard, A.; Renault, J. R.; Michel, B.; Bosshard, H. R.; Delamarche, E., Adv. Mater,. 2000, 12, 1067-1070. Boxer and coworkers have pioneered the development of methods to generate micro-patterned fluid lipid bilayers. Hovis, J. S.; Boxer, S. G., Langmuir, 2000, 16, 894-897 disclose patterning barriers to lateral bilayer membranes by blotting and stamping. Kung, L. A.; Hovis, J. S.; Boxer, S. G., Langmuir, 2000, 16, 6773-6776, disclose patterning hybrid surfaces of proteins and supported lipid bilayers. Based on their work, the potential for creating arrays of membrane-associated receptors at a biocompatible surface which mimics many of the properties of a native cell membrane is clear. However, the fact that these patterned bilayers cannot be removed from water is a serious impediment to their practical implementation which can be overcome by the stabilized membranes of the present invention.

Specifically, the present invention relates to a) an array of protein molecules deposited on a uniformly polymerized lipid membrane; and b) an array of fluid (or partially polymerized) lipid domains in the membrane, separated by a regular array of domains in which the lipids are highly cross-linked.

Exploiting the air stability and biocompatibility of polymerized lipid membranes, microcontact printing (μCP) can be used to generate arrays of protein molecules attached to membrane surfaces in a manner designed to maximize specific activity. In μCP, a poly(dimethylsiloxane) (PDMS) stamp is linked with the molecule of interest, which is then transferred to a planar substrate by stamping. Two recent reviews of μCP and related soft lithography techniques are: (a) Xia, Y.; Whitesides, G. M.; Annu. Rev. Mater. Sci., 1998, 28, 153-184 and (b) Xia, Y.; Rogers, J. A.; Paul, K. E.; Whitesides, G. M., Chem. Rev., 1999, 99, 1823-1848. To date, μCP of proteins has been performed on high energy substrate surfaces (e.g. silica), to which the proteins bind by strong nonspecific interactions (St. John, P. M.; Davis, R.; Cady, N.; Czajka, J.; Batt, C. A.; Craighead, H. G., Anal. Chem., 1998, 70, 1108-1111; Bernard, A.; Delamarche, E.; Schmid, H.; Michel, B.; Bosshard, H. R.; Biebuyck, H., Langmuir, 1998, 14, 2225-2229; Bernard, A.; Renault, J. R.; Michel, B.; Bosshard, H. R.; Delamarche, E., Adv. Mater., 2000, 12, 1067-1070). Although some of the adsorbed molecules retain bioactivity, this method is clearly inefficient since a significant fraction of the adsorbed proteins are likely to be inactivated due to surface-induced denaturation, which is known to occur for proteins immobilized on high energy (e.g. silica) and hydrophobic (e.g. polystyrene) surfaces. Furthermore, when the printed array is subsequently brought into contact with a solution of dissolved proteins (e.g. during bioassay), the regions of the substrate not coated with printed protein will be subject to nonspecific protein adsorption interactions. Thus it is desirable to prepare protein arrays on substrates that are inherently protein-resistant, such as a polymerized supported lipid bilayer.

In one preferred implementation of the present invention, a spatial array of protein molecules is deposited on a uniformly polymerized lipid membrane.

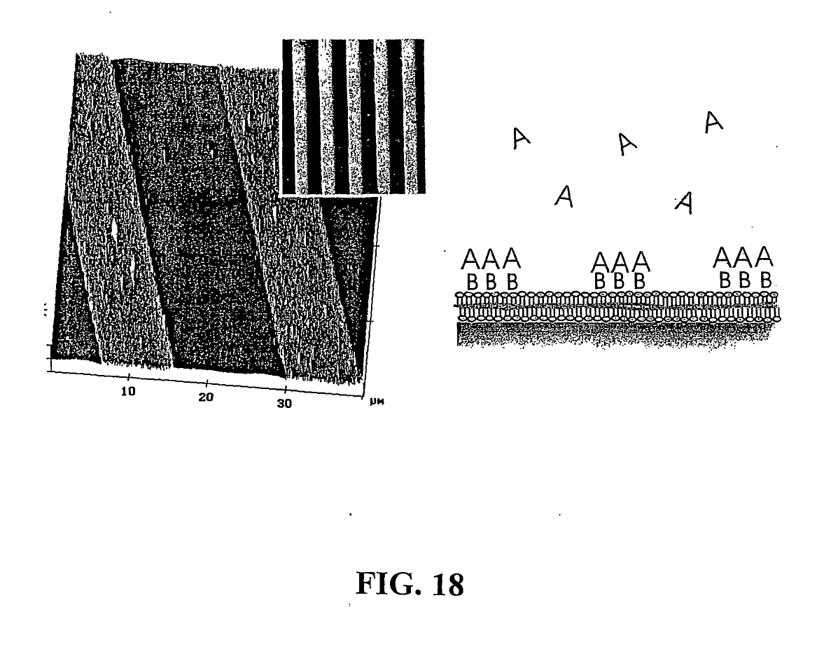

The present inventors have found that arrays of proteins can be deposited by μCP on a uniformly polymerized, supported lipid bilayer when the bilayer surface is dried. Upon subsequent immersion into aqueous solution, the printed proteins remain adhered to the printed areas on the bilayer. Furthermore, the printed proteins retain the capability to bind to other dissolved proteins that are subsequently incubated with the patterned surface. An example is shown in FIG. 18. A bis-SorbPC (redox) bilayer was prepared on a SiO₂ substrate as described above and dried under Ar. A PDMS stamp was inked with a solution of biotin-BSA (BSA molecules bearing covalently attached biotin groups. Stamping was used to create a pattern of biotin-BSA on the lipid bilayer. An AFM image of the biotin-BSA stripes on the dried lipid bilayer is shown on the left side of FIG. 18. The printed bilayer was then immersed in a solution of rhodamine-conjugated avidin (schematic on right side of FIG. 18). The avidin bound to the exposed biotin groups in the regions where biotin-BSA had been printed, but did not adsorb to the non-printed regions, as expected since the bare bis-SorbPC (redox) bilayer is highly protein resistant. An epifluorescence micrograph (inset at center of FIG. 18) shows the emission pattern of rhodamine-conjugated avidin bound to the lipid bilayer, and confirms that binding occurred only in the regions where biotin-BSA had been printed. At this time, it is not known why proteins adsorb strongly and nonspecifically to a dried bilayer, whereas a hydrated bilayer is protein resistant.

Accordingly patterns of proteins can be created on dried, uniformly polymerized, supported lipid membranes. The microcontact printed protein adheres strongly to the printed regions, remains so when the membrane is rehydrated, and retains the capability to specifically bind other ligands, including other proteins. Furthermore, the remaining regions of the membrane retain their characteristic protein resistance.

This implementation can also be performed on polymerized lipid membranes containing any of the types of lipids shown in FIGS. 1-6, or mixtures thereof. Particularly, uCP of proteins can be performed on membranes containing functional lipids having anionic or cationic headgroups, headgroups designed to chelate metal ions, or headgroups designed to covalently react with other molecules. Examples of the latter category include headgroups terminated with thioethanol, maleimido, pyridyldithio, biotinyl, succinimidyl ester, sulfo succinimidyl ester, alkyl halide, or haloacetamide groups. When any of these lipids types is mixed with a second lipid type to form a membrane, the second type of lipid molecule is usually selected to be protein resistant, e.g. bis-SorbPC. The first lipid type is usually selected so that it reacts with the protein molecules that are being printed on the membrane; the objective being to maximize the adherence of the protein to the printed regions on the membrane. For example, uCP of a protein onto a polymerized lipid bilayer containing succinimidyl ester-conjugated lipids will result in formation of a covalent bond between these lipids and the lysine groups on the surface of the protein, thereby firmly attaching the protein to the bilayer surface.

In a second preferred implementation of the present invention, a supported lipid membrane is composed of an array of fluid (or partially polymerized) lipid domains that are separated by a regular array of domains in which the lipids are highly cross-linked.

Transmembrane proteins can be reconstituted into polymerized bilayers as described above. However, to maintain bioactivity, some transmembrane proteins require a fluid membrane environment. Thus, it may be necessary to preserve a domain of fluid lipids in the immediate vicinity of an incorporated protein, while the remainder of the bilayer is polymerized to generate a stabilized membrane.

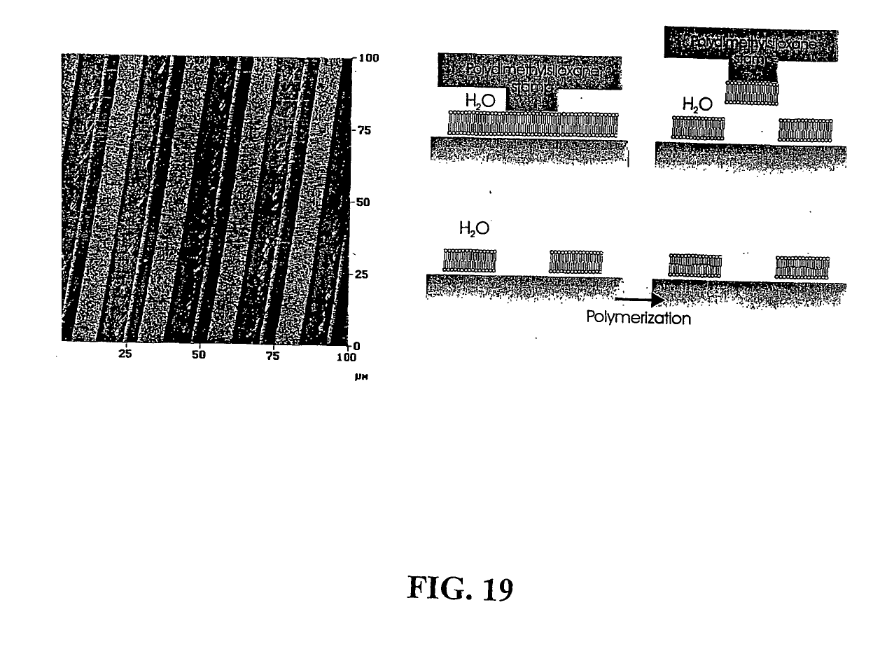

These pattern are preferably created using uCP or photolithographic methods. Specifically, membrane proteins can be reconstituted into microfluid domains within a supported lipid membrane that has undergone patterned polymerization to effect overall stability. For example, a patterned polymerized supported lipid bilayer is shown in FIG. 19. Here, the pattern was obtained using a uCP method developed by Boxer's group (Hovis, J. S.; Boxer, S. G., Langmuir, 2000, 16, 894-897, Kung, L. A.; Hovis, J. S.; Boxer, S. G., Langmuir, 2000, 16, 6773-6776). A PDMS stamp was pressed against and then removed from a fluid bis-SorbPC lipid bilayer on SiO₂ under water; the contacted regions of the bilayer adhered to the stamp and were removed, leaving the underlying glass surface exposed (shown on the right in FIG. 19). UV polymerization of the remaining regions of the bilayer then yielded an air-stable structure from which the AFM image shown on the left in FIG. 19 was acquired. The importance of this result is that it is feasible to regenerate fluid domains between the polymerized domains by incubating the patterned surface with fluid lipid vesicles, which will fuse to the exposed substrate surface between the polymerized regions (Hovis, J. S.; Boxer, S. G., Langmuir, 2000, 16, 894-897) producing a continuous bilayer.

Patterned polymerization is achievable using UV exposure to initiate cross-linking, either through an optical mask or using holography. Here, the UV-light may be polarized or unpolarized. Following polymerization, the unreacted lipids can be dissolved away from the substrate, yielding a pattern of substrate exposed and polymeric bilayer-coated regions. Vesicle fusion can then be used to form fluid bilayer domains between the polymerized regions. Alternatively, “incompletely” polymerized domains of lipids can be created between the highly cross-linked domains. Incomplete polymerization can be achieved, for example, using an appropriate molar ratio of a non-polymerizable lipid and mono-SorbPC and/or bis-SorbPC.

Accordingly, patterned bilayers composed of polymerized and fluid domains can be obtained by uCP printing and UV lithography.

The seventh embodiment relates to the use in sensors. In a seventh embodiment of the present invention, polymerized, supported lipid membranes, with and without associated proteins, are used as nonfouling coatings for chemical sensing and biosensing devices.

In a biosensing device, the characteristic selectivity of biorecognition is exploited in the form of an integrated device that couples a biological binding element, e.g. a protein receptor, to a physical transducer, to perform highly selective analysis of one component (or class of components) in a complex sample matrix (Biosensors: Fundamentals and Applications; A. P. F. Turner, I. Karube, and G. S. Wilson, Eds.; Oxford: New York, 1987; M. A. Arnold and M. E. Meyerhoff, CRC Crit. Rev. Anal. Chem., 1998, 20,149-196). A biochip is a biosensor that presents a spatially defined array of different recognition elements to a sample, permitting parallel analysis of multiple analytes in a single sample (Vo-Dinh, T.; Cullum, B. M.; Stokes, D. L., Sensors and Actuators B, 2001, 74, 2-11). The potential for widespread application of these devices in numerous areas, including drug screening, is well accepted. Supported lipid membranes are useful as transducer coatings for biosensing devices because: a) they preserve the bioactivity of incorporated and/or attached proteins (e.g. P. L. Edmiston and S. S. Saavedra, Biophys. J., 1998, 74, 999-1006; P. L. Edmiston and S. S. Saavedra, J. Amer. Chem. Soc., 1998, 120, 1665-1671; Fischer, B.; Heyn, S. P.; Egger, M.; Gaub, H. E., Langmuir, 1993, 9, 136-140; Salafsky, J.; Groves, J. T.; Boxer, S. G., Biochemistry, 1996, 35, 14773-14781; Z. Salamon, S. Cowell, E. Varga, H. I. Yamamura, V. J. Hruby and G. Tollin, Biophys. J., 2000, 79, 2463-2474.); and b) they resist nonspecific adsorption of non-target proteins that may present in the sample matrix in addition to the analyte (Wisniewski, N.; Reichert, M., Colloids and Surfaces B-Biointerfaces, 2000, 18, 197-219; Eric E. Ross, Bruce Bondurant, Tony Spratt, John C. Conboy, David F. O'Brien, and S. Scott Saavedra, Langmuir, 2001, 17, 2305-2307; Hayward, J. A.; Chapman, D., Biomaterials, 1984, 5, 135-142; Sackman, E. Science, 1996, 271, 43-48).

Polymerized, supported lipid membranes can be used in many types of biosensing devices, including devices based on electrochemical, spectro-electrochemical, or optical (absorbance, luminescence, reflectivity, or scattering) transduction methods. In all cases, a polymerized, supported lipid membrane containing receptors, either water-soluble or membrane-associated receptor proteins or nucleic acids, is present between the physical transducer and the sample solution. The sample solution contains the analyte of interest. Binding of the analyte molecules to the membrane-incorporated receptors is detected at the transducer using, for example, electrochemical, spectro-electrochemical, or optical (absorbance, luminescence, reflectivity, or scattering) methods. The protein resistant properties of the lipid membrane prevent binding of other molecules present in the sample matrix, especially other proteins.

In a preferred implementation, a supported, lipid membrane that contains transmembrane protein receptors is deposited on the transducer surface and polymerized using the preparation methods described above. Binding of ligands to receptors, where the ligands are also analytes, is detected optically as a change in absorbance, luminescence, reflectivity, or scattering at the transducer surface. More preferably the binding is detected using fluorescence methods or surface plasmon resonance methods.

Accordingly, a self-assembled, supported lipid bilayer formed from the types of lipids shown in FIGS. 1-6 can be stabilized to surfactants, organic solvents, and transfer across the water/air interface by cross-linking polymerization of moieties in the acyl chains. The self-assembled, supported lipid membrane of the present invention can be utilized as a protein-resistant coating for molecular devices.

Furthermore, the stabilized lipid membrane of the present invention are suitable as a non-fouling coating for medical implant materials or analytical fluid handling instruments or biomedical devices requiring a non-fouling coating. In addition, they find application as a cell-membrane mimetic for supporting surface-associated and transmembrane proteins in their native state in various biological detection devices (e.g. biosensors). The stabilized phospholipid bilayers of the present invention can also be used as a general non-fouling coating for mass produced commercial items, for example razor blades.

Having generally described this invention, a further understanding can be obtained by reference to certain specific examples which are provided herein for purposes of illustration only, and are not intended to be limiting unless otherwise specified.

### EXAMPLES

General Procedures

Materials:

Bis-sorbyl phosphatidylcholine (bis-SorbPC) was prepared by a modification of the procedure reported by Lamparski, H.; Liman, U.; Frankel, D. A.; Barry, J. A.; Ramaswami, V.; Brown, M. F.; O'Brien, D. F., Biochemistry, 1992, 31, 685-694. The synthesis of bis-dienoyl phosphatidylcholine (bis-DenPC) was adapted from that reported by Dom, K.; Klingbiel, R. T.; Specht, D. P.; Tyminski, P. N.; Ringsdorf, H.; O'Brien, D. F., J. Am. Chem. Soc., 1984, 106, 1627-1633. The synthesis of mono-sorbyl phosphatidylcholine (mono-SorbPC) is described in Lamparski, H., and D. F. O'Brien, Macromolecules, 1995, 28, 1786-1794. The synthesis of dienoyl sorbyl phosphatidylcholine (DenSorbPC) is described in Liu, S.; Sisson, T. M.; O'Brien, D. F., Macromolecules, 2001, 34, 465-473. Lipid structures were established by ¹H NMR and HRMS. In addition the purity was assessed by the presence of only one spot on TLC. All other lipids were purchased from either Avanti Polar Lipids, Inc. (Alabaster, Ala.) or Sigma Chemical.

Potassium persulfate and sodium bisulfate were purchased from Aldrich and used as received. Bovine serum albumin labeled with fluorescein (FITC-BSA, labeling ratio of 11.2:1) and tetramethylrhodamine (TMR-BSA, ratio of 1:0.9) were obtained from Sigma and used without any further purification. Fluorescein labeled dextran (10,000 MW, 2.9:1 labeling ratio) and rhodamine labeled dextran were purchased from Molecular Probes. All other chemicals and solvents were purchased from standard commercial suppliers and used without further purification.

Single crystal (111) silicon wafers having a 20±5 Å thick native oxide layer were purchased from Wacker. Fused silica slides were purchased from Dynasil Corp.

Deionized water (18 MOhms and made organic free (<10 ppb)) was obtained from a Barnstead Nanopure water system.

Substrate preparation: Si wafers and fused silica slides were soaked for 30 minutes in pirhana solution (70% H₂SO₄/30% H₂O₂), followed by extensive rinsing and sonication in deionized water. Unless otherwise noted, substrates were stored in deionized water until used, within 1 hour of cleansing.

Self-assembly of supported lipid bilayers by vesicle fusion: Lipids from stock chloroform or benzene solutions were dried under flowing Ar to remove storage solvents and were then dried overnight under vacuum in ½ dram vials. The lipids were then resuspended in deionized water or in buffer (100 mM NaCl, 10 mM phosphate, pH 7.4) to a final lipid concentration of 0.5 mg/ml. The lipid suspension was then vortexed and sonicated to clarity in a Branson Sonicator fitted with a cup horn (Barrow, D. A.; Lentz, B. R Biochim Biophys Acta 1980, 597, 92-99) to form SUVs. Temperature control was maintained with a water bath and was performed at more than 10 degrees above the reported lipid transition temperature. The SUVs were used within 30 minutes of preparation.

Clean Si substrates (or fused silica) were dried by N₂ immediately prior to fusion. A few drops of lipid vesicle solution (SUVs) were deposited on the Si substrate (or fused silica). Lipids were fused at a temperature equal to or greater than their respective main phase transition temperature for at least ten minutes. The surfaces were then either transferred to test tubes for redox polymerization, or to shallow crystallization dishes to be polymerized by direct UV irradiation. Care was taken to not expose the unpolymerized films to air, or excessive mechanical shocks.

Langmuir-Blodgett Schaefer deposition of supported lipid monolayers and bilayers: Supported lipid films were formed using standard Langmuir-Blodgett-Schaefer techniques according to reference procedures (e.g. Morigaki, K.; Baumgart, T.; Offenhäusser, A.; Knoll, W., Angew. Chem., Int. Ed., 2001, 40, 172; Conboy, J. C.; McReynolds, K. D.; Gervay-Hague, J.; Saavedra, S. S. J. Amer. Chem. Soc., 2002, 124, 968-977; McConnell, H. M.; Watts, T. H.; Weis, R. M. Biochim. Biophys. Acta 1984, 864, 95-106) on a Nima Model 611D Langmuir-Blodgett trough. Care was taken to avoid exposure of polymerizable lipids to visible light that could potentially cause photodegradation; thus prior to polymerization, all manipulations were performed under yellow light.

The first layer of the bilayer was deposited vertically. Langmuir lipid monolayers were spread on a Nima Model 611D Langmuir-Blodgett trough using benzene as the spreading solvent and deionized water as the subphase. Film depositions were performed at a surface pressure of 35-40 mN/m, corresponding to approximately 60 Å²/molecule. The inner leaflet of the bilayer was deposited by withdrawing the substrate from the subphase at a rate of 10 mm/min. Transfer ratios of approximately 98.5% were repeatedly obtained.

The second leaflet of the bilayer structure was deposited using the Langmuir-Schaefer horizontal transfer technique. The substrate with the previously deposited lipid monolayer was passed horizontally through the air-water interface at constant pressure (35-40 mN/m). After formation, the unpolymerized bilayer was maintained in an aqueous environment at all times. All depositions were carried out at 25° C.

Redox polymerization: Redox initiated, radical polymerization was performed with deoxygenated solutions of potassium persulfate and sodium bisulfate. The concentration ratio was 100 mM K₂S₂O₈/10 mM NaHSO₃. Polymerizations were also performed at other K₂S₂O₈/NaHSO₃ concentrations, ranging from 0.001 to 1.0 M. After deposition by vesicle fusion or Langmuir-Blodgett-Schaefer techniques, the supported lipid bilayer is transferred to the Ar-saturated polymerization solution without exposing the bilayer to air, incubated for two hours under flowing Ar, then rinsed extensively with deionized water, and dried under a stream of N₂. A two hour incubation period was determined to be sufficient to achieve near quantitative polymerization of bis-SorbPC bilayers, based on the near quantitative disappearance of the monomer absorbance band at 260 nm during the incubation period. The disappearance of the band was monitored by UV transmission spectroscopy performed (as described in Example 4) on 4 bis-SorbPC bilayers prepared by vesicle fusion as described above.

UV polymerization: UV-induced polymerization of supported lipid films was performed by exposure to UV radiation from a low-pressure mercury pen lamp (Fisher Scientific) with a rated intensity of 4500 mW/cm² at 254 nm. A 1.0 mm thick UV band pass filter from Scott Glass (UG5) was used to remove the short wavelength UV (<230 nm) that can fragment polymer chains into oligomers. In cases where oxygen was to be excluded, the solution in contact with the lipid film was deoxygenated with flowing Ar for at least 30 minutes prior to and throughout the polymerization.

Ellipsometry: The thickness of dried lipid films deposited on Si substrates was determined by ellipsometry. Measurements were made with a Rudolph Research model 43603-200E ellipsometer using a 632.8 nm He—Ne laser at an incident angle of 70 degrees. Initial readings were taken on the bare Si substrates to establish the substrate optical constants and oxide layer thickness prior to any film formation. A refractive index of 1.46 was assumed for all lipid layers. The ellipsometry data were used to calculate the corresponding thickness values using DafIBM version 2.0, a computer program supplied by Rudolph Research and implemented on a DOS-based PC system.

Contact angle measurements: Contact angles of deionized water deposited on supported lipid films were measured using the sessile drop method. In some case, images of multiple 3 mL water droplets on each surface were taken using a Pulnex TM-7CN video camera and Video Snapshot Snappy and were the average of at least three samples. Images were converted into tagged image format using corresponding software, and angles were measured using Image-Pro Plus 1.3 software (Media Cybernetics). In other cases, water droplets on surfaces were photographed using a TE-cooled CCD camera (Princeton Instruments Model 512TK) and the contact angle retrieved via imaging analysis software (Scion Image). Both methods gave equivalent results.

Atomic force microscopy: The surface morphology of supported lipid films was examined by atomic force microscopy (AFM), performed in tapping mode on a Digital Instruments Multimode III microscope. Oxide sharpened silicon nitride tips (TESP-7) were purchased from Digital Instruments, and were tuned to between 300 and 400 kHz. For water immersion studies, measurements were performed in a fluid cell (Digital Instruments) in tapping mode with contact tips tuned to 33 kHz as per supplemental Digital Instrument instructions. Samples were immersed in deionized water for 0.5-1.5 hours before image acquisition commenced. Images were acquired at several areas on each substrate, and images presented in this document are representative of scans from different locations on each sample, different samples, and with different tips used to image the surfaces. Deviations amongst different scan areas on a given film were extremely rare. The samples were not altered by the AFM measurement, as noted by the invariance of successive AFM scans.

Total internal reflection fluorescence (TIRF) spectroscopy: Protein adsorption studies were performed by TIRF spectroscopy. The experimental approach is described in Conboy, J. C.; McReynolds, K. D.; Gervay-Hague, J.; Saavedra, S. S., J. Amer. Chem. Soc., 2002; 124, 968-977. Protein adsorption was measured to fused silica slides coated with lipid films and other types of organic layers, as well as to clean fused silica.

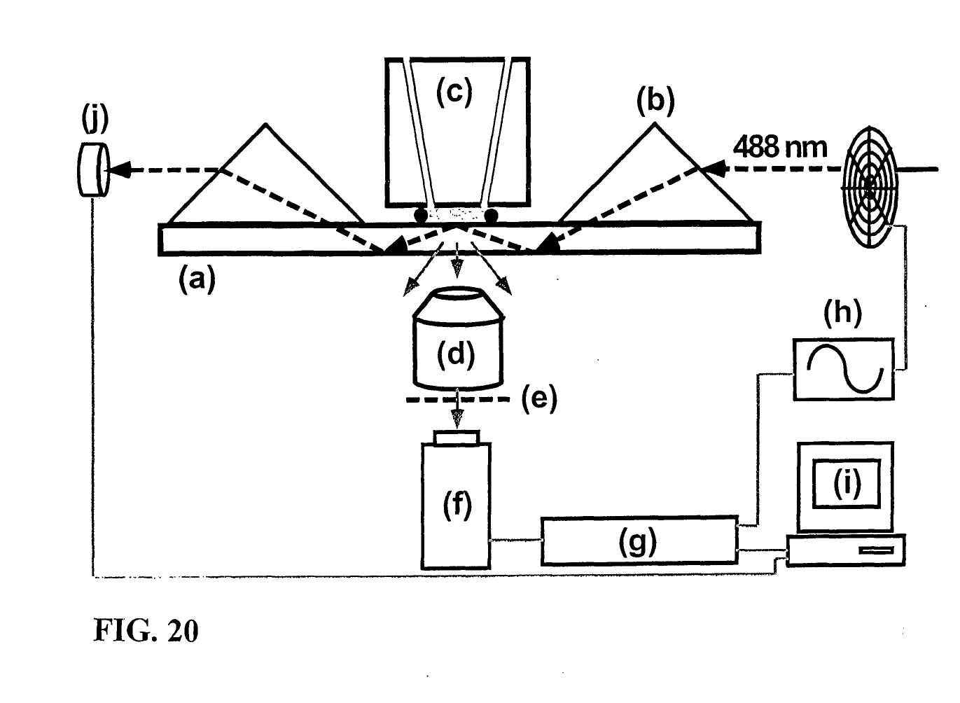

The optical arrangement (FIG. 20) consists of two right-angle quartz prisms mounted in a TIRF flow cell. One prism is used to couple the excitation light from an Ar-ion laser into the cell; the light then propagates by total internal reflection down the fused silica slide. The other prism is used to outcouple the excitation light, thereby reducing scattered light in the cell volume. Index matching fluid (1.463 n_{d}, Cargille) was used to allow for efficient incoupling and outcoupling of the incident laser light.

The flow cell was mounted on a Nikon Diaphot inverted microscope. Excitation wavelengths were 488 nm (for measuring fluorescein emission) or 514 nm (for measuring rhodamine emission). Fluorescence emission was back-collected through the quartz slide with a 4× or 10× objective, optically filtered, and detected with a photomultiplier tube. The incident excitation light was modulated at a frequency of 2.5 kHz. Phase sensitive detection was used to retrieve the fluorescence intensity. The experiment was interfaced to a PC for data collection. All experiments were performed at 25° C.

To determine an equilibrium binding constant for protein adsorption to the surfaces under investigation, solutions of fluorescently-tagged BSA were injected into the flow cell and allowed to equilibrate for 30 min prior to each measurement, which was determined experimentally to be a sufficient time for a steady-state fluorescence intensity to be measured. A Langmuir model was used to extract binding constants from the measured fluorescence intensities, according to published procedures. A modified form of a numerical quantitation method (Hlady, V.; Reinecke, D. R.; Andrade, J. D. J. Colloid Interface Sci. 1986, 111, 555-569) was used to determined the surface coverage of protein molecules from the fluorescence data. Surface coverages were determined relative to reference surfaces known to strongly adsorb all classes of protein molecules (e.g. clean fused silica). A detailed description of the procedures used for determination of equilibrium binding constants and surface coverages has been published and is incorporated herein by reference (Conboy, J. C.; McReynolds, K. D.; Gervay-Hague, J.; Saavedra, S. S., J. Amer. Chem. Soc., 2002; 124, 968-977).

X-ray photoelectron spectroscopy (XPS): XPS was used to determine the chemical composition of supported lipid films. XPS measurements were made on polymerized bilayers supported on silicon wafers using a Kratos 165 Ultra Imaging XPS equipped with a 165 mm mean radius hemispherical analyzer and an eight channeltron detection system. The base pressure in the analyzer chamber was ca. 5×10⁻⁹ Torr. X-rays from the Al Kα line at 1486.6 eV were used for excitation. Electrons were collected in the constant analyzer energy (CAE) mode with a pass energy of 50 keV. Integration times were 0.25 s, co-added four times, for a total of 1.0 s at an interval of 0.1 eV. The areas under the XPS peaks were measured by numerical integration after baseline correction. Relative peak area ratios were calculated using previously published photoionization cross-sections (Schofield, J. J. Electron Spectrosc. Relat. Phenom. 1976, 8, 129-137) after accounting for the transmission properties of the analyzer.

### Example 1

Polymeric bis-SorbPC Films Self-Assembled by Vesicle Fusion; Comparison to Polydiacetylene Lipid Films.

Supported lipid bilayer films composed of bis-SorbPC were self-assembled by vesicle fusion and polymerized by redox initiation as described above. Assuming an index of refraction of 1.46 for the lipid film, the ellipsometric thickness of the dried, polymerized bis-SorbPC bilayer was found to be 46±3 Å. X-ray reflectometry was used to measure the electron density of a dried, polymerized bis-SorbPC bilayer supported on a quartz substrate along the axis normal to the bilayer plane. X-ray reflectivity measurements (kindly perfomed at the National Institute for Standards and Technology by Dr. Jarek Majewski of Los Alamos National Laboratory) yielded a thickness of 45±1.4 Å. Both thickness measurements agree well with the expected thickness for a bilayer composed of fully extended bis-SorbPC. The acyl chains in a bis-SorbPC molecule are shorter by one bond than the acyl chains in a DOPC molecule. The thickness of a bis-SorbPC bilayer should therefore be slightly less than that of a DOPC bilayer, which has been determined to be about 45 Å (Wiener, M. C.; White, S. H., Biophys. J., 1992, 61, 434). Thus the thickness data provide strong evidence that the overall structure of bilayer structure is preserved upon transfer through the water/air interface.

The contact angle of a sessile water drop on a polymerized bis-SorbPC bilayer was 31±4 degrees, consistent with a surface composed of outward facing phosphorylcholine headgroups. For comparison, the water contact angle measurements on a freshly cleaned Si wafer and on a Langmuir-Blodgett transferred monolayer of bis-SorbPC were <5 and 63±5 degrees, respectively. The contact angle for the bis-SorbPC monolayer is lower than that expected for a surface composed of saturated alkyl chains, and reflects the presence of ester groups near the chain termini. Evidence for extensive cross-linking in polymerized, supported bis-SorbPC bilayers is given by the insolubility of these structures in surfactant solution. The ellipsometric thickness did not change upon bath sonication in a 1% solution of Triton X-100 for ten minutes or immersion in chloroform or acetone for 10 seconds (both conditions at room temperature), which suggests that the polymer size in these films is sufficiently large to render them insoluble.

The image in FIG. 8, acquired using tapping mode atomic force microscopy (AFM) in air, shows that the surface of a polymerized, supported bis-SorbPC bilayer is very smooth. The rms of the image in FIG. 8 (left) is 1.25 Å, which is comparable to the bare silicon substrate (rms roughness of 1.1 to 1.3 Å). The bilayer surface morphology was surprisingly uniform; the image shown in FIG. 8 is representative of images acquired at numerous locations over a ca. 1 cm² sample area. No topographical features greater than 1 nm in height (peak-to-peak) were detected. Thus any defects at which bare substrate was exposed were too narrow to be detected by AFM. Polymerized films could be deliberately damaged by repeated, high force scanning; a line scan across a “trough” produced in a film in this manner showed an apparent film thickness of 39-47 Å, consistent with the thickness measurements described above. No discernible chance in film morphology was observed when a previously dried region of a film was rehydrated and then re-imaged under water (FIG. 8 (center)).

Supported bilayers composed of a mixture of bis-SorbPC and the non-polymerizable lipid DOPC at a molar ratio of 7 to 3 were also prepared by vesicle fusion and polymerized by redox initiation as described above. These films are observed to contain numerous defects as revealed by AFM (FIG. 14). This result shows that polymerized bilayer films that contain appreciable amounts of unpolymerized lipids are not stable to removal from water.

Supported bis-SorbPC bilayers, self-assembled by vesicle fusion as described above, were also polymerized by direct UV irradiation, as described above, and characterized by ellipsometry, AFM, and contact angle measurements, etc. In comparison to redox polymerized bis-SorbPC films, the UV polymerized bis-SorbPC films were thinner and less hydrophilic. Specifically, the film thickness was approximately 29 Å and the water contact angle was 52 degrees. AFM images shown in FIG. 13 illustrate that relative to redox polymerized bis-SorbPC films (rms roughness of 0.13 nm), the UV polymerized films are rougher (rms roughness=0.35 mm), and have discernable features or domains approximately 1.5 to 2 nm thick. These features are very uniformly distributed on the film surface; no regions were found that were devoid of polymer film, or where the domains differed appreciably in size.

For comparison purposes, supported lipid bilayers were also prepared using a commercially available, polymerizable diacetylenic PC lipid (1,2-bis(10,12-tricosadionyl)sn-glycero-3-phosphocholine (DAPC); Avanti Polar Lipids). Supported bilayers of DAPC were prepared by Langmuir-Blodgett-Schaefer deposition, as described above, and photopolymerized using UV light (procedures for this lipid are described in detail in Morigaki, K.; Baumgart, T.; Offenhausser, A.; Knoll, W., Angew. Chem., Int. Ed., 2001, 40, 172). Polymerization of DAPC films could not be induced with oxygen present in the solution contacting the bilayer; negligible film thickness resulted if the solution was not purged thereof before and during polymerization. After polymerization and drying, supported DAPC bilayers produced an ellipsometric thickness of 55 Å. However, AFM imaging showed that these films were highly nonuniform. The example shown in FIG. 12 contains relatively large defects, some of which extended down to the substrate. Line scans generally showed two defect depths of defects, 2.5-3 nm and 4.5-6 nm. Thus the performance of the present invention is superior to existing technology, as a comparison of FIGS. 8 and 12 clearly shows.

### Example 2

Polymeric Lipid Bilayers Self-Assembled by Vesicle Fusion From Other Sorbyl and Dienoyl Lipids.

Supported bilayers composed of mono-SorbPC were also self-assembled by vesicle fusion and polymerized by redox initiation as described above. The quality of the resulting films was generally poorer that the corresponding bis-SorbPC films. The ellipsometric thickness was measured to be 31 Å, and the AFM images (e.g. FIG. 15) revealed domain-like features similar to those observed for UV polymerized bis-SorbPC films. This result is consistent with the observation in vesicle studies that a cross-linked lipid polymer is more stable to solvent and surfactant dissolution than a linearly polymerized lipid polymer.

Supported bilayers composed of DenSorbPC were self-assembled by vesicle fusion and polymerized by redox initiation as described above. Polymerized DenSorbPC bilayers were indistinguishable from polymerized bis-SorbPC films by AFM. (FIG. 17). The measured ellipsometric thickness of 45 Å was nearly identical as well, and upon bath sonication in surfactant, only a minute thickness change was observed. The sessile water contact angle was measured to be 42 degrees, which is slightly less hydrophilic in comparison to a redox polymerized bis-SorbPC bilayer.

The redox polymerization of supported bis-DenPC lipid bilayers self-assembled by vesicle fusion also produced relatively thick films. The ellipsometric thickness measured after drying the film was 52 Å; however upon bath sonication in the surfactant Triton-X-100, a significant decrease in film thickness was observed. AFM images of the film after sonication in surfactant reveal the surface to contain defects located uniformly throughout the film (e.g. FIG. 16). Linescans across the defects indicate that they do not reach the substrate (depth less than 3 nm); this is consistent with lipid loss from only the outer leaflet of bilayer.

From the domain-like structure of the films shown FIGS. 13-16, it is clearly feasible to generate a partially polymerized film that contains a regular array of microscopic voids. By performing vesicle fusion on these films, it should be possible to fill the voids with a second type of lipid, either polymerizable or non-polymerizable, and thus generate a mixed film containing a non-uniform spatial distribution of lipid types.

### Example 3

Extent of BSA Adsorption to Polymerized, Supported Lipid Films and Reference Surfaces.

To examine the effect that cross-linking has on the nonspecific protein adsorption properties of a fluid PC bilayer, the degree of BSA adsorption to both UV and redox polymerized bis-SorbPC bilayers was measured using TIRF spectroscopy, and compared to BSA adsorption to a fluid 1-palmitoyl-2-oleolylPC(POPC) bilayer.

Redox polymerized and UV polymerized bis-SorbPC bilayers were self-assembled by vesicle fusion on fused silica substrates according to Example 1, rinsed and dried under nitrogen, mounted in the TIRF flow cell (FIG. 20), and rehydrated. POPC bilayers were fused to silica substrates that were preassembled in the cell, to avoid exposure of the fluid bilayer to air.

The extent of BSA adsorption was also measured for several reference surfaces:
(1) a supported DAPC bilayer, prepared and UV polymerized on fused silica as described in Example 1, then rehydrated in the TIRF flow cell;
(2) a clean quartz substrate, which served as a model of a hydrophilic surface at which nonspecific protein adsorption is highly favored;
(3) a ‘tail-group out’ monolayer of arachidic acid (AA), which served as a model of a hydrophobic surface at which nonspecific protein adsorption is highly favored. AA monolayers were deposited using the Langmuir-Blodgett method on fused silica substrates, which were then mounted in the flow cell and hydrated.

Each type of surface was equilibrated with TMR-BSA (bovine serum albumin labeled with tetramethylrhodamine isothiocyanate) solution (1 mg/ml, containing 50 mM phosphate buffer, pH 7.4) for 30 minutes before the flow cell was flushed with buffer and TIRF emission from the adsorbed protein film was measured. Relative TMR-BSA surface coverages were determined using the calibration procedures described above (Hlady, V.; Reinecke, D. R.; Andrade, J. D. J. Colloid Interface Sci. 1986, 111, 555-569; Conboy, J. C.; McReynolds, K. D.; Gervay-Hague, J.; Saavedra, S. S., J. Amer. Chem. Soc., 2002; 124, 968-977); the calibration solutions had known concentrations of dissolved (i.e. non-adsorbed) TMR-BSA.

The bar graph in FIG. 9 shows the relative TMR-BSA adsorption to all surfaces listed above. The BSA surface coverages on the redox polymerized bis-SorbPC and fluid POPC bilayers were 6±3% and 6±6%, respectively, of that obtained on the hydrophobic AA monolayer (100±24%; estimated to be ca. one monolayer). The statistical equivalence of the BSA surface coverage on the bis-SorbPC (redox) and fluid POPC bilayers demonstrates that the native resistance of the fluid bilayer to nonspecific protein adsorption is retained upon polymerization of the hydrophobic tails of the bis-SorbPC monomers, and provides further evidence that the “headgroup out” structure of the bis-SorbPC bilayer is preserved after drying and rehydration.

Furthermore, approximately 70% of the TMR-BSA adsorbed to the bis-SorbPC (redox) bilayer could be removed by flushing the cell with a 1% Triton X-100 solution. No increase in the amount of adsorbed TMR-BSA was observed when the surface was re-exposed to 1 mg/ml TMR-BSA, which demonstrates the stability of the polymeric bis-SorbPC bilayer to surfactant solutions.

The relative protein adsorption on the DAPC bilayer (40%) was slightly less than the 47% measured on clean fused silica (which is labeled as quartz in FIG. 9). The relative adsorption on UV photopolymerized bis-SorbPC bilayers was 24%, intermediate between bis-SorbPC (redox) and DAPC.

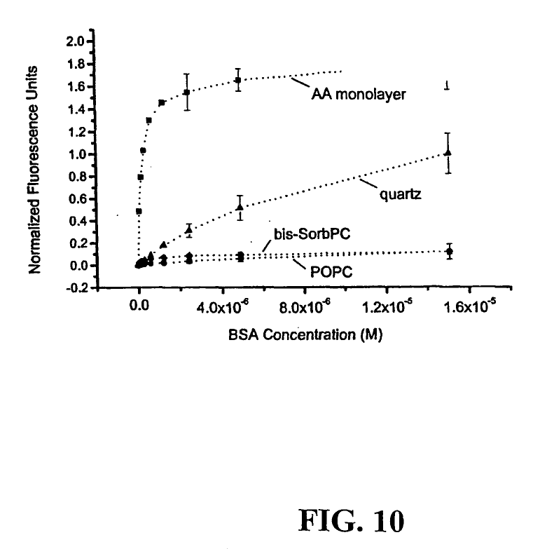

TIRF isotherms for TMR-BSA adsorption to several of these surfaces were measured over a protein concentration range of 5.0×10⁻⁹ M to 1.5×10⁻⁶ M and are plotted in FIG. 10. The raw data were calibrated as described above, allowing the magnitude of the normalized fluorescence intensities plotted in FIG. 10 to be directly compared. The shape of the adsorption isotherms and relative measured intensities show that the BSA interacts most strongly with the hydrophobic AA monolayer surface. Relative protein adsorption to the bis-SorbPC (redox) and POPC bilayers is very similar.

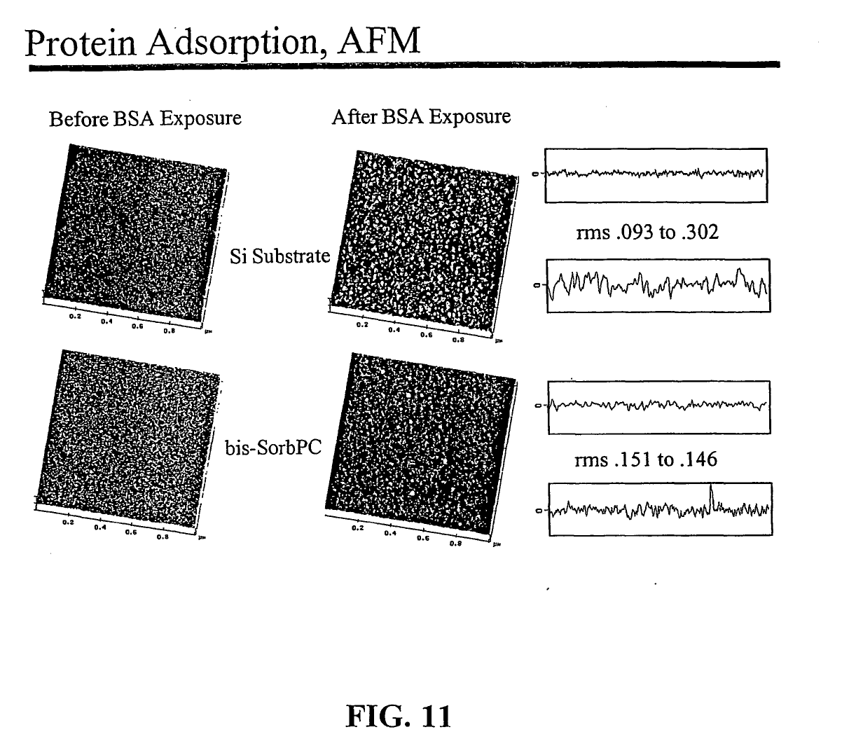

AFM images and line scans of a silicon wafer and a wafer coated with a bis-SorbPC (redox) bilayer are shown in FIG. 11. The surfaces were imaged both before and after incubation in a 1 ml/mg BSA solution (conditions given above). Consistent with the TIRF data, a significant increase in measured roughness occurs on the SiO₂ surface, which is due to the considerable protein adsorption that occurs on clean SiO₂. In contrast, a negligible change is observed for the bis-SorbPC (redox) bilayer, consistent with its demonstrated protein resistance.

These results compare favorably with published data. At a dissolved BSA concentration of ca. 0.05 g/L, Yang et al. (Yang, Z.; Galloway, J. A.; Yu, H., Langmuir, 1999, 15, 8405) reported a BSA surface coverage of ca. 6% on methoxy-terminated polyethylene glycol) self-assembled monolayers, relative to the coverage measured on glass. At dissolved BSA concentrations of 0.05 and 2 g/L, Murphy and Lu (Murphy, E. F.; Lu, J. R.; Lewis, A. L.; Brewer, J.; Russell, J.; Stratford, P., Macromolecules, 2000, 33, 4545) measured BSA surface coverages on hydrogel polymers with incorporated phosphorylcholine groups of 20% and 36%, respectively, relative to SiO₂. Thus the degree of non-specific BSA adsorption on a redox polymerized bis-SorbPC membrane is comparable to or better than that reported for other protein resistant surfaces.

### Example 4

bis-SorbPC and bis-DenPC Bilayers Formed by Langmuir-Blodgett Techniques and UV Polymerized.

Preparation of supported lipid films: Substrates (either Si wafers or fused silica slides) were first sonicated in 50% isopropyl alcohol/50% water (v/v), rinsed in deionized water, and then cleaned in piranha solution as described above. The cleaned substrates were then sonicated in a 0.1 M solution of AlCl₃ for 30 minutes, rinsed repeatedly with deionized water, sonicated for 15 minutes in deionized water, and then rinsed again. This procedure resulted in hydrophilic substrates having with a sessile water contact angle of 10±3.5 degrees. Planar supported lipid bilayers (PSLBs) were deposited on substrates using Langmuir-Blodgett-Schaefer techniques and maintained under water until after polymerization was performed.

UV Polymerization: The low-pressure mercury pen lamp was held 7.5 cm from the PSLB-coated substrate and illuminated for 4 minutes. The water solution contacting the PSLB was purged with Ar for 30 minutes prior to polymerization. After UV exposure, the PSLB was removed from solution, rinsed several times with deionized water and dried with a stream of nitrogen.

Kinetics of Polymerization: Kinetic experiments were performed on a Spectral Instruments 440 UV-Vis spectrometer. Bilayer films were deposited on four individual quartz slides which were mounted together in a fluid cell and kept equidistant by the presence of 2 mm thick, 25 mm OD Viton o-rings. The two slides in the center of the cell had bilayers on each side, whereas the slides on the outside of the cell had one bilayer on the inner (hydrated) surface. This arrangement allowed measurements to be performed simultaneously on six lipid bilayers that were maintained under water; thus sufficient sensitivity was obtained in a transmission geometry. Absorbance spectra were collected at various time intervals after exposure to polymerizing UV irradiation. The kinetic data were retrieved from the absorption spectra by integrating the absorbance peak at 260 nm after baseline correction.

Protein Adsorption Studies: Increasing concentrations of FITC-labeled BSA in 150 mM phosphate buffered saline (50 mM. phosphate, 150 mM NaCl, pH 7.4) were injected into the TIRF flow cell (FIG. 20) and allowed to equilibrate for 30 min prior to each measurement of fluorescence intensity. Calibration to determine the surface coverage of adsorbed protein was performed by measuring the fluorescence from several standard solutions of FITC-labeled dextran injected into the flow cell, as described in Conboy, J. C.; McReynolds, K. D.; Gervay-Hague, J.; Saavedra, S. S., J. Amer. Chem. Soc., 2002; 124, 968-977. Surface coverages were measured relative to the coverage on a reference surface, here a Langmuir-Blodgett deposited monolayer of POPC. The tail group-out” orientation of the POPC molecules in the monolayer makes this surface highly hydrophobic, and consequently it nonspecifically adsorbs protein strongly. This calibration procedure also allows for normalization of fluorescence adsorption isotherms measured for different samples.

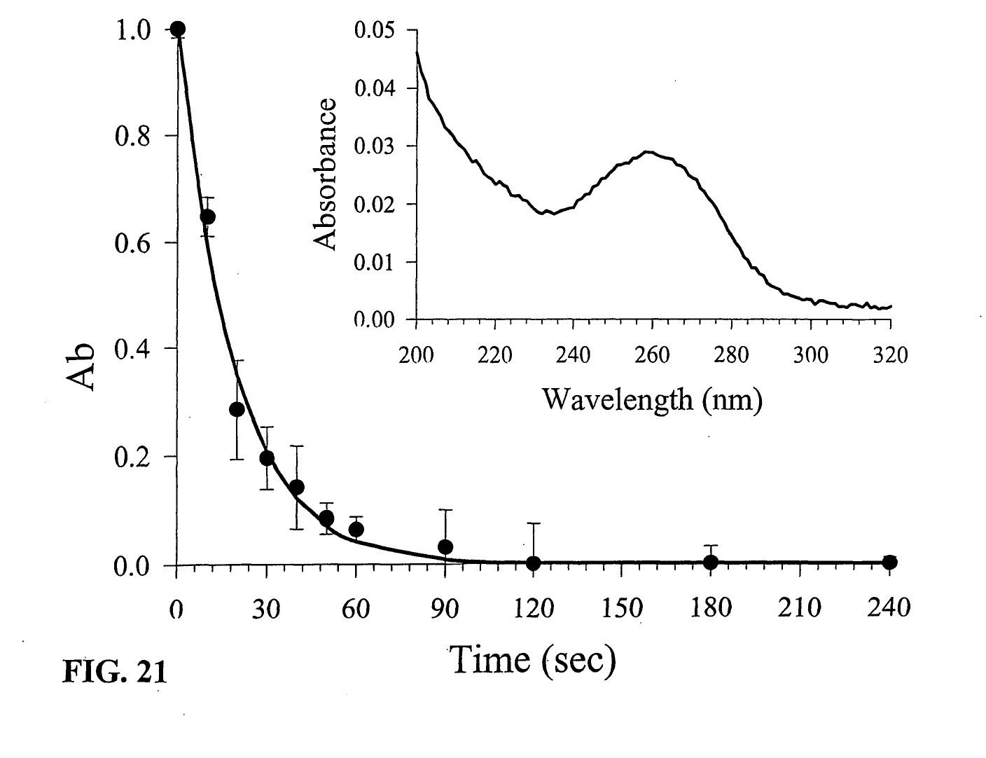

Results: The kinetics of polymer formation during UV irradiation of bis-SorbPC bilayers was measured by UV-vis absorbance spectroscopy. The bis-SorbPC monomer has an absorption maximum at 260 nm (Lamparski, H.; O'Brien, D. F., Macromolecules, 1995, 28, 1786-1794), as shown in the inset in FIG. 21. By monitoring the depletion of the monomer absorbance as a function of exposure time to filtered UV light from the low-pressure mercury lamp, the rate of polymerization was determined. Example data are shown in FIG. 21. Complete disappearance of the monomer absorbance is observed at times greater than 2 minutes, which was taken as complete polymerization of the bilayer. The decay of the integrated monomer absorbance occurs at a rate of 18.9±0.96 per second. Irradiation of bilayer bis-SorbPC films for times greater than 2 minutes was found not to alter the film structure or morphology as observed by AFM and ellipsometry (described below). However, irradiation times below 2 minutes result in substantially reduced degrees of polymerization.

Static water contact angle and ellipsometry measurements made on bilayers of UV polymerized bis-SorbPC are listed in Table 1. Also tabulated for comparison are the contact angle and ellipsometric thickness of a bis-SorbPC monolayer polymerized under the same conditions as the bis-SorbPC bilayers as well as a bis-DenPC bilayer. The measured thickness of 48.4 Å for bis-SorbPC is consistent with a fully extended lipid bilayer structure. A static water contact angle of 41.9?3.1 degrees is indicative of a hydrophilicity intermediate between SiO₂ (about 10 degrees) and bis-SorbPC monolayer (60.4 degrees), which has a “tail group out” orientation.

TABLE 1

| Film | Contact Angle | Ellipsometry |
|---|---|---|
| bis-Sorb PC (monolayer) | 60.4 ± 3.9 | 26.2 ± 3.1 |
| bis-Sorb PC (bilayer) | 41.9 ± 3.1 | 48.4 ± 4.2 |
| bis-DenPC (bilayer) | 65.2 ± 2.4 | 25.2 ± 4.9 |

Contact angle and elipsometric data for a polymerized bis-SorbPC monolayer and bilayer. Also shown for comparison is the data for a polymerized bis-DenPC bilayer.

In contrast, polymerization and drying of a bis-DenPC bilayer yields a film of only monolayer thickness, with a contact angle similar to that measured for a bis-SorbPC monolayer. The fact that only a monolayer is observed is a consequence of the structure of bis-DenPC (FIG. 3) which precludes the possibility of covalent bonding between the two lipid monolayers in a polymeric lipid bilayer. In contrast, interlayer bonding is likely in a bis-SorbPC bilayer since the reactive moieties are located at the chain termini, and is probably required to create an air-stable bilayer.

The presence of the polymerized, supported bis-SorbPC film was also confirmed by XPS. A carbon to nitrogen (C/N) elemental ratio of approximately 42±6.3:1 was measured. This result indicates that the chemical composition of the surface layer is consistent with that of a bis-Sorb PC lipid layer (calculated C/N ratio of 38:1) within the error inherent in the XPS data (typically 15%).

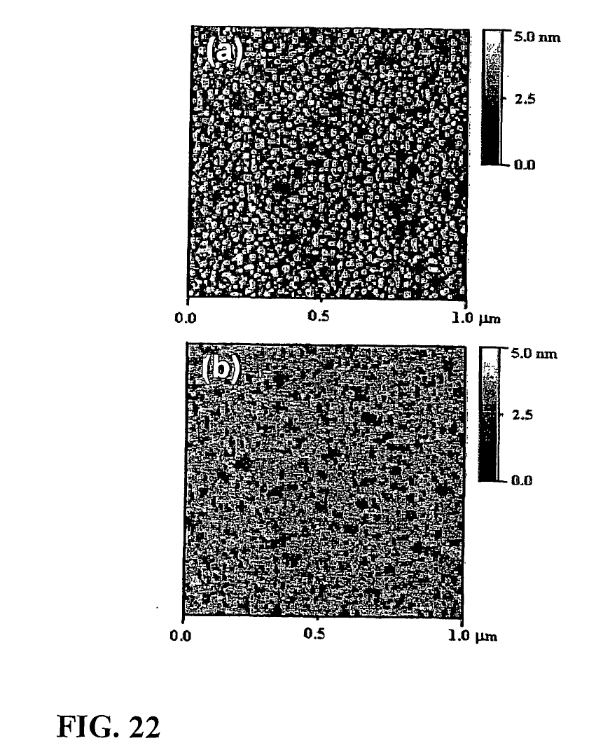

AFM was used to characterize the morphology of polymerized bis-SorbPC bilayers. AFM images of a dehydrated and hydrated (i.e. immersed in deionized water) polymerized bis-SorbPC bilayer are displayed in FIG. 22a and FIG. 22b respectively. Surprisingly different morphologies are seen for the water-immersed surface versus the same film in air. In the dry state, the surface of the bilayer appears as a uniformly coated surface with small irregularly shaped circular domains roughly 10-50 Å in diameter, ranging in height from 5-10 Å. Larger voids are also apparent on the surface, 60?15 nm in diameter with depths ranging from 15-25 nm. The rms roughness for the dehydrated surface, FIG. 22a, is 5.2±1.4 Å. The roughness of the underlining silicon substrate was measured as 2.1±1.6 Å. The topographical depth determined by AFM is 48-52 Å, which is comparable to the thickness determined by ellipsometry.

Upon immersion in water the surface morphology changes considerably, as shown in FIG. 22b. The previously “cracked” surface becomes much more uniform and the calculated surface roughness declines to 3.5±0.8 Å. The large voids, which were present in the dried sample, are still apparent although the mean size decreases to roughly 40 nm in diameter with the void depth remaining constant at 20±5 nm. Analysis of the hydrated AFM image shows that approximately 36±8% of the surface area corresponds to large and smaller voids within film which extend to a depth of 15-20 Å.

The probable origin of these voids is loss of unreacted lipid monomers or low molecular weight oligomers from the upper leaflet of the bilayer upon removal of the structure from water.

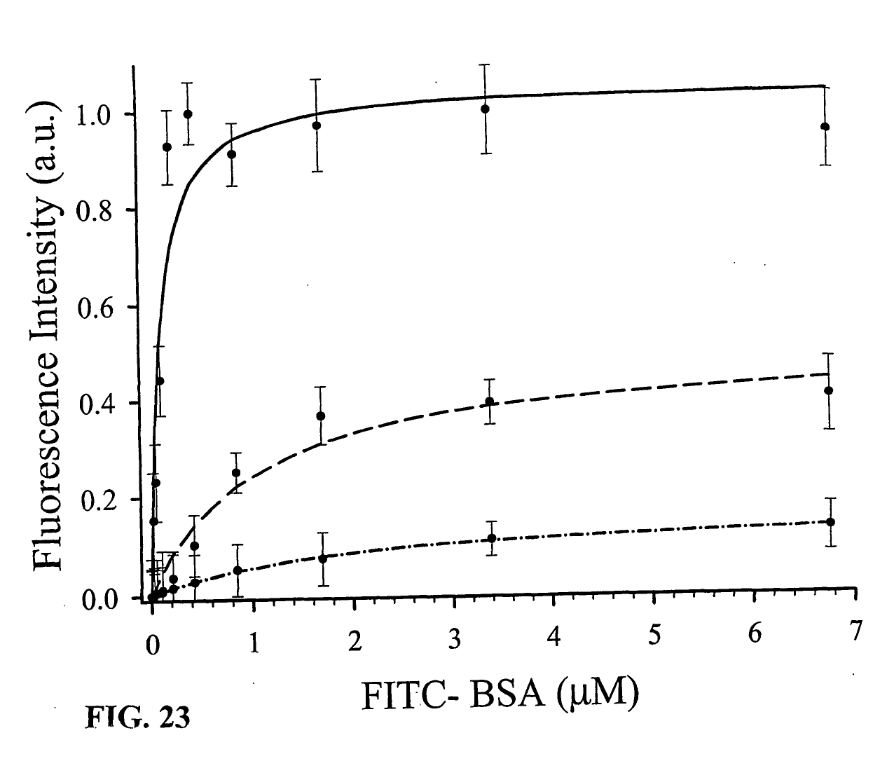

To assess the biocompatibility of UV polymerized lipid bilayers and more specifically to determine if the protein resistance of a fluid lipid bilayer is preserved upon lipid polymerization, protein adsorption studies were performed. Nonspecific adsorption of fluorescein labeled bovine serum albumin (FTIC-BSA), measured using TIRF spectroscopy, was used to quantitatively compare the protein resistance of bis-SorbPC bilayers to fluid POPC (1-palmitoyl-2-oleolylphosphatidylcholine) lipid bilayers. UV polymerized bis-SorbPC bilayers on fused silica were prepared as described, dried, and then rehydrated after mounting in the TIRF flow cell. POPC bilayers were deposited on fused silica slides using Langmuir-Blodgett-Schaefer techniques and mounted in the TIRF flow cell without exposure to air. Measurements were also made on a hydrophobic reference surface, which was a Langmuir-Blodgett deposited, “tail group out” POPC monolayer. Representative adsorption isotherms are plotted in FIG. 23. The binding affinities were extracted from the adsorption isotherms using a Langmuir model and are summarized in Table 2. The surface coverage data were normalized by assuming that protein adsorption was minimal on POPC bilayers and that monolayer coverage occurred on POPC monolayers.

TABLE 2

| | | | % surface |
|---|---|---|---|
| Surface | Kₐ | Fₘₐₓ | coverage |
| POPC (monolayer) | 9.8 ± 2.9 × 10⁶ | 1.0 ± 0.067 | 100 ± 6.7 |
| bis-SorbPC | 9.1 ± 2.1 × 10⁵ | 0.51 ± 0.049 | 35 ± 3.4 |
| (polymerized, dried, | | | |
| and rehydrated) | | | |
| POPC (bilayer) | 4.8 ± 0.32 × 10⁵ | 0.16 ± 0.0046 | 0 |

Comparison of BSA adsorption to POPC monolayer, POPC bilayer and UV polymerized bis-SorbPC bilayer films.

Both the binding affinity and surface coverage data show that the protein resistance of a UV polymerized bis-Sorb Bilayer falls in between that of a POPC monolayer and a POPC bilayer. The TIRF adsorption isotherm for a POPC bilayer and a re-hydrated bis-SorbPC bilayer are similar in shape, with an increase in protein adsorption observed for the polymer bilayer, as indicated by an increase in total fluorescence and an increase in the binding affinity. Both effects are attributed to the non-uniformity of the polymer films which have exposed hydrophobic domains as seen in the AFM images.

A more quantitative examination of protein adsorption reveals a direct correlation between exposed hydrophobic domains on the polymer surface and the amount of adsorbed BSA. The relative percent surface concentrations of adsorbed BSA were determined by using the fluorescent intensity, Fₘₐₓ, obtained by the nonlinear least squares fit to the adsorption data for each case. The measured percentage of void space on the polymer bilayers in the hydrated state, as determined by AFM, is approximately 36%. This correlates well with the 41±4.5% monolayer coverage of BSA measured for this same surface by TIRF, after correcting for finite amount of nonspecific protein adsorption to the fluid POPC bilayer.

In summary, this example shows that air-stable, supported lipid bilayers can be formed by Langmuir-Blodgett-Schaefer deposition and UV-induced polymerization. The performance of these films (stability and protein resistance) is better than that of films formed from commercially available polymerizable lipids (i.e. DAPC) but is less optimal as compared to bis-SorbPC (redox) bilayers formed by vesicle fusion (see example 1).

### Example 4

Reconstitution of Transmembrane Proteins into Polymerized Lipid Bilayers.

This example shows that transmembrane protein activity can be supported in the polymerized bis-SorbPC films. Two transmembrane proteins, cytochrome c oxidase (CcO), and human delta opiod receptor (d-OR), were used in these experiments. CcO was isolated from fresh beef hearts and purified according to published procedures (T. Soulimane and G. Buse, Eur. J. Biochem., 227(1995) 588-595). d-OR was expressed, isolated, and purified from a transfected cell line, also according to published procedures (Salamon, S. Cowell, E. Varga, H. I. Yamamura, V. J. Hruby and G. Tollin, Biophys. J., 2000, 79, 2463).

Detergent dialysis (described above) was used to insert each of these proteins into bilayer vesicles, forming proteo-vesicles, following standard procedures (Mimms, L. T.; Zampighi, G.; Nozaki, Y.; Tanford, C.; Reynolds, J. A. Biochemistry 1981, 20, 833-840). The surfactant used was octyl glucoside. The surfactant concentration was initially 40 mM, well above the reported cmc of about 20 mM, and the lipid to protein ratio was 1000:1. Proteo-vesicles were formed using either pure bis-SorbPC or pure DOPC, and then fused to silica substrates to form planar supported proteo-lipid bilayers. Supported bilayers containing bis-SorbPC were redox polymerized as described above. TIRF spectroscopy was used to measure the specific binding of ligands to both types of planar supported proteo-lipid bilayers; the experimental design was equivalent to that used to measure nonspecific BSA adsorption to lipid membrane surfaces, as described above.

CcO binds cytochrome c (Cyt c) in low ionic strength solutions; raising the ionic strength dissociates the complex. TMR-Cyt c binding to bis-SorbPC and POPC bilayers containing CcO was compared. Although Cyt c nonspecifically adsorbs to lipid bilayers to some extent, this can be distinguished from specific binding to membrane-bound CcO by the difference in ionic strength dependence (i.e. rinsing with a high ionic strength buffer solution dissociates specifically bound Cyt c).

After incubating the CcO-bis-SorbPC bilayer with TMR-Cyt c for 30 minutes, the flow cell was flushed with low ionic strength buffer and the fluorescence corresponding to adsorbed TMR-Cyt c was measured. Flushing the cell with a high ionic strength (0.5M NaCl) solution removed specifically bound TMR-Cyt c, which was 80% of the total adsorbed Cyt c. This high removal percentage indicates that a significant population of CcO molecules are properly oriented and retain specific binding activity after polymerization of bis-SorbPC membrane. By comparison, on bis-SorbPC films with no incorporated CcO, less than 20% of the adsorbed Cyt c was removed by the NaCl rinse. Furthermore, if the polymerized bilayer was dried and then rehydrated before assaying the binding activity, the removal percentage decreased only slightly to 74%.

Using a TIRF calibration procedure (described above) with TMR-labeled dextran as the calibrant, the surface coverage of the specifically bound TMR-Cyt c was determined to be 9.8±4.5×10⁻¹⁴ mol/cm². A comparable value, 8.1±3.8×10⁻¹⁴ mol/cm², was measured for CcO-functionalized fluid DOPC bilayers. Both of these surface coverages are within reasonable range of the theoretically calculated CcO surface coverage of 5.5×10⁻³ mol/cm², assuming a 1000 to 1 lipid to protein ratio in the film. In summary, CcO binding activity equivalent to a CcO-functionalized DOPC bilayer was retained in bis-SorbPC bilayers even after redox polymerization, drying and rehydration.

d-OR selectively binds many opioid peptides, among them the ligand enkephalin analogue [D-Pen2, D-Pen2]enkephalin (DPDPE) (Mosberg, H. I.; Hurst, R.; Hruby, V. J.; Gee, K.; Yamamura, H. I.; Galligan, J. J.; Burks, T. F. Proc. Natl. Acad. Sci. U.S.A. 1983, 80, 5871-5874.) Analagous to the procedure for CcO, d-OR was incorporated into fluid DOPC and polymerized bis-SorbPC lipid films and assayed for binding activity using a fluorescently labeled ligand, TMR-DPDPE. After the labeled ligand was incubated with each type of d-OR functionalized lipid film, the film was rinsed. Competitive desorption was effected by subsequent incubation with unlabeled ligand, DPDPE, and revealed the fraction of the TMR-DPDPE that was specifically associated with each proteo-lipid film. 40% and 60% of the adsorbed TMR-DPDPE was competitively desorbed by DPDPE on the polymerized bis-SorbPC and fluid DOPC films respectively (both films were functionalized with d-OR). Thus in both cases, a significant population of active opioid receptors was present in the bilayer. These data indicate that polymerization does not significantly affect receptor activity.

### Example 5

Patterning Polymerized Lipid Bilayers and Proteins on Polymerized Lipid Bilayers.

In this example, results are presented for two types of patterned arrays created by microcontact printing (μCP): (a) Protein films are patterned on polymerized bis-SorbPC bilayers. (b) Patterned regions of polymerized bis-SorbPC are created by selective removal of portions of the fluid bilayer prior to the polymerization step.

Poly(dimethylsiloxane) (PDMS) stamps were made by curing Sylgard 184 (Dow Corning) on a silicon master with line features (i.e. stripes) approximately 10 microns wide separated by 15 micron wide spaces. The PDMS stamp was then removed from the master, rinsed in deionized water.

To create pattern type (a), the stamp was immersed in an aqueous solution of 0.05 mg/ml BSA in 50 mM, pH 7.4, phosphate buffer for 30 minutes. The protein-coated stamp was rinsed with buffer and water, and then placed upon a dried, bis-SorbPC (redox) bilayer supported on a Si wafer. Light pressure (50-100 g over a 1 cm² area) was applied to the stamp; then it was removed after 20 seconds. The bilayer was then rinsed with deionized water, dried, and imaged by atomic force microscopy. FIG. 18 shows an AFM image of the pattern of protein “stripes” that was transferred to the bilayer surface from the stamp. The protein stripes are quite uniform and the protein appears to be located exclusively in the patterned regions. In another experiment, biotin-labeled BSA was printed onto a dried, bis-SorbPC (redox) bilayer supported on a fused silica slide. Subsequently, the slide was immersed into an aqueous solution of TMR-labeled avidin. TMR-avidin bound specifically to the biotin-BSA stripes, with minimal adsorption observed in the unprinted regions of the film, which shows that these regions retain their characteristic protein resistance. The inset in FIG. 18, an epifluorescence micrograph taken of the bilayer after rinsing away the unbound TMR-avidin, shows the fluorescent stripes of TMR-avidin bound to the printed surface. These experiments demonstrate the feasibility of printing arrays of proteins onto dried lipid polymer films. The microcontact printed protein adheres strongly to the dried bilayer, remains in place when the membrane is rehydrated, and retains the capability to specifically bind other ligands, including other proteins.

To create pattern type (b), a μCP printing technique developed to create patterns in hydrated, fluid lipid bilayers (Hovis, J. S.; Boxer, S. B., Langmuir, 2000, 16(3), 894-897; Hovis, J. S.; Boxer, S. B., Langmuir, 2001, 17(11), 3400-3405) was adapted to create polymerized lipid bilayer patterns. A schematic of the process is shown in FIG. 19 (right). A fluid bilayer of bis-SorbPC was formed by vesicle fusion on a clean Si wafer according to the procedures described above. The PDMS stamp was made to briefly (5 seconds) contact the bilayer while both are immersed in water. Withdrawing the stamp from the bilayer surface removed those portions of the fluid bilayer that were in contact with the stamp (i.e. 15 μm wide stripes). The remaining, 10 μm wide stripes of fluid bis-SorbPC bilayer were then UV polymerized as described in Example 1. The AFM image shown on the left side of FIG. 19 was obtained on the dried sample. The bright lines are polymerized bilayer; between them are wider, darker lines, which are the regions where the bilayer was removed. Much thinner lines of polymerized material are visible in the dark regions; this was caused by incomplete removal of lipid, which was probably due to imperfections on the surface of the stamp. From the array-like structure of the film shown FIG. 19, it is clearly feasible to generate a polymerized film that contains a regular array of “bare areas.” By performing vesicle fusion on such a film, it should be possible to fill the bare areas vacated by the patterning process with a second type of lipid, either polymerizable or non-polymerizable, and thus generate a mixed film containing a defined spatial array of different types of lipids.

Numerous modifications and variations on the present invention are possible in light of the above teachings. It is therefore to be understood that within the scope of the appended claims, the invention may be practiced otherwise than as specifically described herein.

1. A method for the self-assembly and stabilization of a lipid membrane at a solid surface, comprising:
depositing a lipid monolayer or a lipid multilayer on a substrate, thereby obtaining a supported lipid monolayer or a supported lipid multilayer;
in situ polymerizing said supported lipid monolayer or said supported lipid multilayer, thereby obtaining a polymerized membrane.

2. The method according to claim 1, wherein said polymerized membrane is at least partly cross-linked.

3. The method according to claim 1, wherein said supported lipid monolayer or said supported lipid multilayer are formed by fusion of fluid, small unilamellar vesicles comprising a polymerizable lipid.

4. The method according to claim 3, wherein said polymerizable lipid contains at least one of the polymerizable group selected from the group consisting of a styryl group, a dienyl group, a dienoyl group, a sorbyl group, an acryloyl group, a methacryloyl group, a vinyl ester group and a mixture thereof.

5. The method according to claim 3, wherein said polymerizable lipid has a lipid tail having 14 to 22 carbon atoms.

6. The method according to claim 3, wherein said lipid tail is an unsaturated or saturated linear tail or an unsaturated or saturated branched tail.

7. The method according to claim 3, wherein a head group of said polymerizable lipid is selected from the group consisting of phosphatidylcholine, phosphatidic acid, phosphatidylethanolamine and phosphatidylserine.

8. The method according to claim 3, wherein said polymerizable lipid is terminated with a succinate group, a metal chelating group, a thioethanol group, a maleimido group, a pyridyldithio group, a biotinyl group, a succinimidyl ester group, a sulfo succinimidyl ester group, a alkyl halide group, a haloacetamide group, an ethylene glycol-based oligomer group or an ethylene glycol-based polymer group.

9. The method according to claim 1, wherein said solid surface is a silicon dioxide surface, a silicon oxide surface, a noble metal surface, a mica surface, a polymer surface, an indium-tin oxide surface, a tin oxide surface, an indium oxide surface, a steel surface or a silicon surface.

10. The method according to claim 1, wherein said in situ polymerizing is initiated by a redox initiator system.

11. The method according to claim 10, wherein said redox initiator system is K₂S₂O₈/NaHSO₃.

12. The method according to claim 1, wherein said in situ polymerizing occurs by irradiation with UV-rays, visible rays, near infrared rays or γ-rays.

13. The method according to claim 12, wherein said UV-rays have a wavelength of between 230 and 350 nm.

14. The method according to claim 12, wherein said VIS-rays have a wavelength of between 350 and 700 nm.

15. The method according to claim 12, wherein said near infrared rays have a wavelength of between 700 and 1000 nm.

16. The method according to claim 12, wherein said UV-rays, visible rays or near infrared rays are polarized or unpolarized.

17. The method according to claim 3, wherein said polymerizable lipid is mixed with a non-polymerizable amphiphile.

18. The method according to claim 17, wherein said non-polymerizable amphiphile is a lipid or a surfactant.

19. The method according to claim 3, wherein a mixture of at least two polymerizable lipids is used.

20. The method according to claim 1, wherein a membrane protein is incorporated into said polymerized membrane.

21. The method according to claim 1, wherein water soluble protein is bonded to or adsorbed to said polymerized membrane.

22. The method according to claim 1, wherein a structure of said polymerized membrane is preserved upon transfer into air and exposure to a surfactant solution or an organic solvent.

23. A polymerized membrane obtained by the method according to claim 1.

24. The polymerized membrane according to claim 23, wherein said polymerized membrane is at least partly cross-linked.

25. The polymerized membrane according to claim 23, wherein said membrane is obtained using a mixture of a polymerizable lipid and a non-polymerizable amphiphile.

26. The polymerized membrane according to claim 25, wherein said non-polymerizable amphiphile is a lipid or a surfactant.

27. The polymerized membrane according to claim 23, wherein said membrane is obtained using a mixture of at least two polymerizable lipids.

28. The polymerized membrane according to claim 23, wherein a membrane protein is incorporated into said polymerized membrane.

29. The polymerized membrane according to claim 23, wherein a water soluble protein is bonded to or adsorbed to said polymerized membrane.

30. The polymerized membrane according to claim 23, wherein a structure of said polymerized membrane is preserved upon transfer into air and exposure to a surfactant solution or an organic solvent.

31. A spatially addressable, planar array of molecules deposited on the membrane according to claim 23.

32. The array according to claim 31, wherein said membrane has a linearly polymerized portion and a cross-lined portion.

33. A surface coated with the membrane according to claim 23.

34. The surface according to claim 33, wherein said membrane comprises a protein.

35. The surface according to claim 33 which is a silicon dioxide surface, a silicon oxide surface, a noble metal surface, a mica surface, a polymer surface, an indium-tin oxide surface, a tin oxide surface, an indium oxide surface, a steel surface or a silicon surface.

36. The surface according to claim 33, wherein said polymerized membrane is at least partly cross-linked.

37. The surface according to claim 33, wherein said membrane is obtained using a mixture of a polymerizable lipid and a non-polymerizable amphiphile.

38. The surface according to claim 37, wherein said non-polymerizable amphiphile is a lipid or a surfactant.

39. The surface according to claim 33, wherein said membrane is obtained using a mixture of at least two polymerizable lipids.

40. The surface according to claim 33, wherein a membrane protein is incorporated into said polymerized membrane.

41. The surface according to claim 33, wherein a water soluble protein is bonded to or adsorbed to said polymerized membrane.

42. The surface according to claim 33, wherein a structure of said polymerized membrane is preserved upon transfer into air and exposure to a surfactant solution or an organic solvent.

44. The surface according to claim 33, which is included in a medical implant material, an analytical fluid handling instrument, a biomedical device or a personal care product.

45. A medical implant material, an analytical fluid handling instrument, a biomedical device or a personal care product, comprising:
the membrane according to claim 23; and
a solid surface.

46. The medical implant material, the analytical fluid handling instrument, the biomedical device or the personal care product according to claim 44,
wherein said solid surface is selected from the group consisting of a silicon dioxide surface, a silicon oxide surface, a noble metal surface, a mica surface, a polymer surface, an indium-tin oxide surface, a tin oxide surface, an indium oxide surface, a steel surface, a silicon surface and a combination thereof.

47. The medical implant material, the analytical fluid handling instrument, the biomedical device or the personal care product according to claim 45,
which contacts a biological sample or an organism.

48. The medical implant material, the analytical fluid handling instrument, the biomedical device or the personal care product according to claim 45, wherein said personal care product is a razor blade.
